(19) United States
(12) Patent Application Publication
(10) Pub. No.: US 2019/0257189 A1
(43) Pub. Date: Aug. 22, 2019

(54) Determining Direct Hit or Unintentional Crossing Probabilities for Wellbores

(71) Applicant: Gyrodata, Incorporated, Houston, TX (US)

(72) Inventor: Jon Bang, Trondheim (NO)

(21) Appl. No.: 16/277,980

(22) Filed: Feb. 15, 2019

Related U.S. Application Data
(60) Provisional application No. 62/632,285, filed on Feb. 19, 2018.

(51) Int. Cl. E21B 47/022; G06F 17/18; E21B 47/04; E21B 47/09; G01V 1/42

(52) U.S. Cl. CPC E21B 47/022; G06F 17/18; G01V 1/42; E21B 47/09; E21B 47/04

(57) ABSTRACT

Various implementations directed to determining direct hit or unintentional crossing probabilities for wellbores are provided. In one implementation, a method may include receiving wellbore trajectory data and uncertainty data for a reference wellbore section and for an offset wellbore section. The method may further include determining an analysis point in the reference wellbore section based on the received wellbore trajectory data. The method may additionally include determining segments for the offset wellbore section based on the received wellbore trajectory data. In addition, the method may include determining combined uncertainties corresponding to the analysis point and the segments based on the received uncertainty data. The method may also include determining direct hit probabilities between the analysis point and the segments based on the combined uncertainties. The method may further include drilling, or providing assistance for drilling, the reference wellbore section based on the direct hit probabilities.

### CROSS-REFERENCE TO RELATED APPLICATIONS

This application claims the benefit of U.S. provisional patent application Ser. No. 62/632,285, filed Feb. 19, 2018 and titled QUANTIFICATION OF WELLBORE-COLLISION PROBABILITY, the entire disclosure of which is herein incorporated by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Various forms of directional drilling may be used to generate wellbores for the exploration and development of oil and gas fields, including techniques for drilling a second wellbore in proximity to a first wellbore. However, because of uncertainties associated with initial surface positions of the first and second wellbores, along with inaccuracies associated with surveying tools, surveying procedures, and survey measurements related to the drilling of the first and second wellbores, there may be some uncertainties associated with the surveyed and reported positions of the first and second wellbores. As a result of these uncertainties, an unplanned collision between the two wellbores may occur, which could cause significant economic, environmental, and health and safety ramifications.

### SUMMARY

Described herein are implementations of various technologies relating to determining direct hit or unintentional crossing probabilities for wellbores. In one implementation, a method may include receiving wellbore trajectory data for a reference wellbore section and for an offset wellbore section. The method may also include receiving uncertainty data for the reference wellbore section and for the offset wellbore section. The method may further include determining an analysis point in the reference wellbore section based on the received wellbore trajectory data. The method may additionally include determining a plurality of segments for the offset wellbore section based on the received wellbore trajectory data, where each segment is symmetrical about a center point of the segment. In addition, the method may include determining a plurality of combined uncertainties corresponding to the analysis point and the plurality of segments based on the received uncertainty data. The method may also include determining a plurality of direct hit probabilities between the analysis point and the plurality of segments based on the plurality of combined uncertainties. The method may further include drilling, or providing assistance for drilling, the reference wellbore section based on the plurality of direct hit probabilities.

In another implementation, a method may include receiving wellbore trajectory data for a reference wellbore section and for an offset wellbore section. The method may also include receiving uncertainty data for the reference wellbore section and for the offset wellbore section. The method may further include determining a plurality of segments for the offset wellbore section based on the received wellbore trajectory data, where each segment is symmetrical about a center point of the segment. The method may additionally include determining a plurality of analysis points in the reference wellbore section based on the received wellbore trajectory data. In addition, the method may include determining a plurality of intervals for the reference wellbore section based on the plurality of analysis points, where a respective interval is formed by a pair of respective analysis points of the plurality of analysis points. The method may also include determining a plurality of combined uncertainties for the plurality of analysis points and the plurality of segments based on the received uncertainty data. The method may further include determining a plurality of direct hit probabilities between the plurality of intervals and the plurality of segments based on the plurality of combined uncertainties. The method may additionally include drilling, or providing assistance for drilling, the reference wellbore section based on the plurality of direct hit probabilities.

In yet another implementation, a method may include receiving wellbore trajectory data for a reference wellbore section and for an offset wellbore section. The method may also include receiving uncertainty data for the reference wellbore section and for the offset wellbore section. The method may further include determining an analysis point in the reference wellbore section based on the received wellbore trajectory data. The method may additionally include determining a cylindrical coordinate system based on the analysis point and the received wellbore trajectory data. In addition, the method may include determining a plurality of wedges in the cylindrical coordinate system, where the plurality of wedges includes a region proximate to the offset wellbore section. The method may also include determining a plurality of combined uncertainties corresponding to the analysis point and the plurality of wedges based on the received uncertainty data. The method may further include determining a plurality of unintentional crossing probabilities between the analysis point and the offset wellbore section within the plurality of wedges based on the plurality of combined uncertainties. The method may additionally include drilling, or providing assistance for drilling, the reference wellbore section based on the plurality of unintentional crossing probabilities.

In yet another implementation, a method may include receiving wellbore trajectory data for a reference wellbore section and for an offset wellbore section. The method may also include receiving uncertainty data for the reference wellbore section and for the offset wellbore section. The method may further include determining one or more analysis points in the reference wellbore section based on the received wellbore trajectory data. The method may additionally include determining a plurality of segments for the offset wellbore section based on the received wellbore trajectory data, where each segment is symmetrical about a center point of the segment, and where the plurality of segments comprises a region proximate to the offset wellbore section. In addition, the method may include determining a plurality of combined uncertainties corresponding to the one or more analysis points and the plurality of segments based on the received uncertainty data. The method may also include determining a plurality of unintentional crossing probabilities between the one or more analysis points and the offset wellbore section within the plurality of segments based on the plurality of combined uncertainties. The method may further include drilling, or providing assistance for drilling, the reference wellbore section based on the plurality of unintentional crossing probabilities between the one or more analysis points and the offset wellbore section within the plurality of segments.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of a survey operation in accordance with implementations of various techniques described herein.

FIG. 2 illustrates a schematic diagram of a multiple wellbore environment in accordance with implementations of various techniques described herein.

FIG. 3 illustrates a schematic diagram of a multiple wellbore environment in accordance with implementations of various techniques described herein.

FIG. 4 illustrates a flow diagram of a method for determining one or more direct hit probabilities between a reference wellbore point (M_{R}) of a reference wellbore section and an offset wellbore section in accordance with implementations of various techniques described herein.

FIG. 5 illustrates a flow diagram of a method for determining one or more direct hit probabilities between reference wellbore section and an offset wellbore section in accordance with implementations of various techniques described herein.

FIG. 6 illustrates a flow diagram of a method for determining one or more unintentional crossing probabilities between a reference wellbore point (M_{R}) of a reference wellbore section and an offset wellbore section in accordance with implementations of various techniques described herein.

FIG. 7 illustrates a schematic diagram of a multiple wellbore environment in accordance with implementations of various techniques described herein.

FIG. 8 illustrates a schematic diagram of a multiple wellbore environment in accordance with implementations of various techniques described herein.

FIG. 9 illustrates a graphical diagram of an uncertainty ellipsoid for a multiple wellbore environment in accordance with implementations of various techniques described herein.

FIGS. 10A-10B illustrate graphical diagrams of a multiple wellbore environment in accordance with implementations of various techniques described herein.

FIGS. 11A-11B illustrate schematic diagrams of a multiple wellbore environment in accordance with implementations of various techniques described herein.

FIG. 12 illustrates three principal orientations of a cylindrical segment in a XYZ coordinate system in accordance with implementations of various techniques described herein.

FIGS. 13A-13B illustrate graphical plots of Taylor coefficients for a multiple wellbore environment in accordance with implementations of various techniques described herein.

FIG. 14 illustrates a graphical diagram of a multiple wellbore environment using along-hole coordinates in accordance with implementations of various techniques described herein.

FIGS. 15A-15B illustrate schematic diagrams relating to unintentional crossings in a multiple wellbore environment in accordance with implementations of various techniques described herein.

FIGS. 16A-16B illustrate schematic diagrams relating to unintentional crossings in a multiple wellbore environment in accordance with implementations of various techniques described herein.

FIGS. 17A-17B illustrate schematic diagrams relating to a multiple wellbore environment in accordance with implementations of various techniques described herein.

FIG. 18 illustrates a schematic diagram relating to a multiple wellbore environment in accordance with implementations of various techniques described herein.

FIG. 19 illustrates a schematic diagram of a multiple wellbore environment in accordance with implementations of various techniques described herein.

FIG. 20 illustrates cross-sectional schematic diagrams of a multiple wellbore environment in accordance with implementations of various techniques described herein.

FIG. 21 illustrates a schematic diagram of a computing system in which the various technologies described herein may be incorporated and practiced.

### DETAILED DESCRIPTION

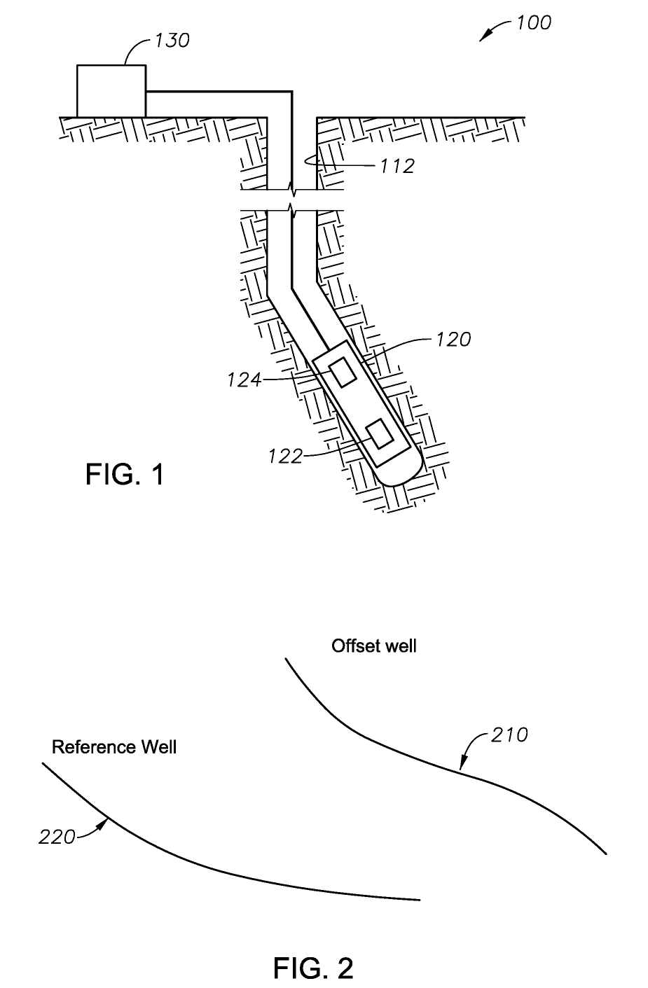

Various implementations directed to determining direct hit or unintentional crossing probabilities for wellbores will now be described in the following paragraphs with reference to FIGS. 1-21.

To obtain hydrocarbons such as oil and gas, directional wellbores may be drilled through Earth formations along a selected trajectory. The selected trajectory may deviate from a vertical direction relative to the Earth at one or more inclination angles and at one or more azimuth directions with respect to a true north along the length of the wellbore. As such, measurements of the inclination and azimuth of the wellbore may be obtained to determine a trajectory of the directional wellbore.

As is known in the art, a directional survey may be performed to measure the inclination and azimuth at selected positions (i.e., survey stations) along the wellbore. In particular, a survey tool may be used within the wellbore to determine the inclination and azimuth along the wellbore. The survey tool may include sensors configured to generate measurements corresponding to the instrument orientation with respect to one or more reference directions, to the Earth's magnetic field, and/or to the Earth's gravity, where the measurements may be used to determine azimuth and inclination along the wellbore.

For example, the survey tool may include one or more accelerometers configured to measure one or more components of the Earth's gravity, where these measurements may be used to generate an inclination angle and a toolface angle of the survey tool. In addition, the survey tool may include one or more magnetic sensors configured to measure one or more components of the Earth's magnetic field, where the measurements may be used to determine an azimuth and inclination along the wellbore. Further, the survey tool may include one or more gyroscopic sensors configured to measure one or more components of the Earth's rotation rate about one or more orthogonal axes of the survey tool, where the measurements may be used to determine an azimuth and inclination along the wellbore. Other sensors known to those skilled in the art may also be used, such as those used to acquire depth measurements within the wellbore. Measurements from one or more of these sensors may then be used to compute an inclination and/or an azimuth of the survey tool, and, hence, an inclination and/or an azimuth of the wellbore at the location of the survey tool within the wellbore.

As is also known in the art, the survey tool can be used to perform a survey and/or collect measurements in conjunction with various applications, such as measurement-while-drilling (MWD) applications, gyro-while-drilling (GWD) applications, wireline surveys, slickline surveys, drop surveys, and/or any other applications known to those skilled in the art. For such applications, the survey tool may be of any type known to those skilled in the art.

For example, FIG. 1 illustrates a schematic diagram of a survey operation 100 in accordance with implementations of various techniques described herein. As shown, the survey operation 100 may be performed using a survey tool 120 and a computing system 130. The computing system 130 is discussed in greater detail in a later section.

The survey tool 120 may be similar to the survey tool discussed above. The survey tool 120 may be disposed within a wellbore 112, and may be used in conjunction with various applications, such as those discussed above. For example, the survey tool 120 may be part of a downhole portion (e.g., a bottom hole assembly) of a drill string (not pictured) within the wellbore 112. In particular, the survey tool 120 may be a MWD survey tool, where it may be part of a MWD drill string used to drill the wellbore 112. In conventional systems, the MWD survey tool 120 may be used to acquire measurements while the drill string is drilling the wellbore 112 and being extended downwardly along the wellbore 112. Further, the survey tool 120 may include one or more magnetic sensors 122, one or more accelerometers 124, one or more gyroscopic sensors (not shown), and/or any other sensors known to those skilled in the art.

The implementations for the survey tool described above may be used in multiple well environments, such as for drilling a second wellbore in proximity to a first wellbore. As is known in the art, a second wellbore may be drilled in proximity (e.g., parallel) to a first wellbore for various purposes, including, but not limited to, twin wells for steam assisted gravity drainage (SAGD), in-fill drilling, target interceptions, coal bed methane (CBM) well interceptions, synthesis gas well interceptions, river crossings, and/or the like. For such scenarios, the existing (i.e., first) wellbore may hereinafter be referred to as an offset wellbore, and the new (i.e., second) wellbore being planned or drilled may hereinafter be referred to as a reference wellbore.

FIG. 2 illustrates a schematic diagram of a multiple wellbore environment in accordance with implementations of various techniques described herein. In particular, as shown, a reference wellbore 220 may be drilled in proximity to an offset wellbore 210. Further, the offset wellbore 210 and/or the reference wellbore 220 may be surveyed using one or more survey tools discussed above, such as with a MWD survey tool or with a gyroscopic survey tool.

In some instances, during the course of surveying the reference wellbore and/or the offset wellbore, one or more wellbore position uncertainties may arise. In particular, these uncertainties may come about due to uncertainties associated with initial surface positions of the wellbores, along with inaccuracies associated with surveying tools, surveying procedures, and survey measurements of conducted surveys of the wellbores. The wellbore position uncertainties may accumulate over the length of a survey, and they may, for relatively long wellbores and/or poor surveys, amount to position inaccuracies of hundreds of feet. These uncertainties may therefore be of significant importance for the placement of new wellbores, such as in areas with existing wellbores, near faults, near high-pressure zones, and/or the like.

As known in the art, various methods and procedures have been used to analyze and estimate the wellbore position uncertainties. For example, error models have been used to estimate such uncertainties. Error models may include models and descriptions that detail the error (i.e., uncertainty) sources within individual surveying tools, and these models may also detail how these error sources accumulate into the wellbore position uncertainties. The error models may be used together with surveyed wellbore positions in an error model analysis, and the error model analysis can then be used to generate the estimates of the wellbore position uncertainties. Examples of error models may include those which detail errors associated with MWD instruments and gyroscopic instruments. Other error models may include models relating to methods for quality control (QC) of surveys, models relating to surface location uncertainties, models relating to correlations between uncertainties in different wells, and/or the like.

In some scenarios, due to the uncertainty regarding positions of the wellbores, an unplanned collision between the reference wellbore and the offset wellbore may occur. In particular, an unplanned collision may occur when the reference wellbore and/or offset wellbore have non-negligible wellbore position uncertainties. Such an unplanned collision between the two wellbores may lead to significant economic, environmental, and health and safety consequences.

As such, to avoid these unplanned collisions, one or more collision probabilities for the offset wellbore and the reference wellbore may be evaluated. A collision probability, as further defined later, may be the probability of a reference wellbore colliding with an offset wellbore, or may be the probability of the reference wellbore traversing to a particular area that extends beyond the offset wellbore. In one implementation, the one or more collision probabilities may be estimated based on the wellbores' position uncertainties. In practice, these collision probabilities may be used to safely guide the drilling of the reference wellbore. In particular, the collision probabilities may be evaluated in a well planning phase and/or at critical stages during a drilling phase. In some scenarios, a drilling operator may use these probabilities to make decisions on whether to follow or alter a drilling plan, such as in real-time (i.e., during drilling). In such scenarios, the drilling operator may accept a higher probability of a low-consequence collision (e.g., a purely financial loss) than of a high-consequence collision (e.g., a serious health, safety, or environmental related outcome).

In view of the above, various implementations described herein may be used to determine one or more collision probabilities based on wellbore position uncertainties. The one or more collision probabilities may include one or more direct hit (DH) and/or unintentional crossing (UC) probabilities for a reference wellbore and an offset wellbore.

A DH probability may be defined as a probability of a direct hit event occurring between a reference wellbore and an offset wellbore. A direct hit event between the wellbores may refer to well-to-well contact between the wellbores, such as when the reference wellbore is drilled directly into the offset wellbore. A direct hit event may also include a scenario where the reference wellbore is drilled such that it damages a cemented zone and/or a pressure zone around the offset wellbore, or otherwise jeopardizes the safety and integrity of the offset wellbore. A UC probability may be defined as a probability of an unintentional crossing event occurring between a reference wellbore and an offset wellbore. An unintentional crossing event between the wellbores may refer to instances where the reference wellbore inadvertently traverses into a region proximate to the offset wellbore that the reference wellbore is planned to avoid. In one implementation, the region may include a volume that is approximately bounded by a surface of the offset wellbore that faces the reference wellbore, and the volume may extend in a direction beyond the offset wellbore section and away from the reference wellbore, when viewed from the reference wellbore. In such an implementation, for an unintentional crossing event, the reference wellbore is considered to have “crossed” the offset wellbore once it has traversed into this region.

As such, a drilling operator may use a determination of the DH probability when making decisions regarding drilling, as a direct hit event between the wellbores may, as explained above, lead to significant economic, environmental, and health and safety consequences. In addition, a drilling operator may use a determination of the UC probability when making decisions regarding drilling, as an unintentional crossing event may indicate a relatively low knowledge of the relative positions of the wellbores, and it could potentially lead to a direct hit if the reference wellbore is steered in an incorrectly-presumed safe direction.

For the implementations described below, the DH and UC probabilities are determined using calculations made from one or more points in the reference wellbore versus one or more points or sections in the offset wellbore. However, in view of the discussion below, those skilled in the art will understand that the DH and UC probabilities may also be determined using calculations made from one or more points in the offset wellbore versus one or more points or sections in the reference wellbore. Further, the DH and UC probabilities may be evaluated when either the offset or reference wellbores are in the well planning phase and/or the drilling phase.

### Direct Hit (DH) Probability

One or more methods may be used to determine one or more DH probabilities between a reference wellbore and an offset wellbore. In particular, the one or more DH probabilities may be determined at various points and/or intervals along each wellbore.

In one implementation, and as further explained below, a method may be used to determine one or more DH probabilities between an offset wellbore section and a reference wellbore point of a reference wellbore. In another implementation, a method may be used to determine one or more DH probabilities between a reference wellbore section and an offset wellbore section. In some implementations, the reference wellbore section may refer to any portion of the reference wellbore, including the entirety of the reference wellbore that has been drilled. Similarly, in some implementations, the offset wellbore section may refer to any portion of the offset wellbore, including the entirety of the offset wellbore that has been drilled.

As further described below, the one or more direct hit probabilities may be determined based on wellbore position uncertainties for the reference wellbore section and for the offset wellbore section. Data corresponding to the wellbore position uncertainties may hereinafter be referred to as uncertainty data. As mentioned above, the uncertainty data may be determined based on various methods and procedures, such as error models. As is known in the art, uncertainty data may be determined at several locations down each wellbore, such as at each survey station.

At each such location, the determined uncertainty data may be represented mathematically by a covariance matrix. The covariance matrix may be the three-dimensional (3D) equivalent to a one-dimensional (1D) variance, and the covariance matrix may provide a complete description of a spatial 3D uncertainty for a particular location in a wellbore. In some implementations, the determined uncertainty data for a location may be centered at that location. For example, the determined uncertainty data for a location may be centered on the center line of a surveyed well path.

Further, the covariance matrices representing the uncertainty data may be generated in a north-east-vertical (NEV) coordinate system. However, as known in the art, a covariance matrix may be expressed in other coordinate systems similar to the NEV coordinate system. Furthermore, as is also known in the art, the wellbore position uncertainty in a two-dimensional (2D) plane or along a 1D direction can be obtained from the 3D covariance matrix. The process of extracting the 2D or 1D wellbore position uncertainties may be referred to as projecting the 3D covariance matrix, and the resulting 2D covariance matrix or the 1D variance may be referred to as projections of the 3D covariance matrix.

For the uncertainty data at a particular location in a wellbore, the confidence region of the wellbore position uncertainty (equivalent to, for example, the +−1σ interval in 1D, where σ is the standard deviation) may be represented by a volume in 3D or an area in 2D. The 3D volume may be an ellipsoid with three principal axes, possibly with different lengths. The 2D area may be an ellipse with two principal axes, possibly with different lengths. The ellipsoid and ellipse may be referred to as the Ellipsoid of Uncertainty and the Ellipse of Uncertainty, respectively, and both may hereinafter be abbreviated as EOU. The length and orientations of the axes of the EOU may be determined from the covariance matrix. Further, similar to projecting the 3D matrix to yield the 2D matrix or the 1D variance, the 3D EOU can be projected onto a 2D plane or onto a 1D direction. This projection may yield a representation of wellbore position uncertainty for a location in the respective plane or direction.

As further described below, to facilitate the determinations of one or more DH probabilities between a reference wellbore section and an offset wellbore section based on the uncertainty data, a point pair (i.e., one point in each wellbore) may be considered, the uncertainties at these points may be combined, and the combined uncertainty may be assigned to the reference wellbore section. The combined uncertainty may be expressed by a 3D covariance matrix, which may be analogous to the individual covariance matrices of the respective points.

In addition, to further facilitate determining the DH probabilities, the radii of the reference and offset wellbore sections may be combined, and the combined radii may be assigned to the offset wellbore section. The volume of the offset wellbore section with the combined radii may be labeled as V_{DH}, where the volume may represent a tubular, “unwanted” region that the reference wellbore is to avoid.

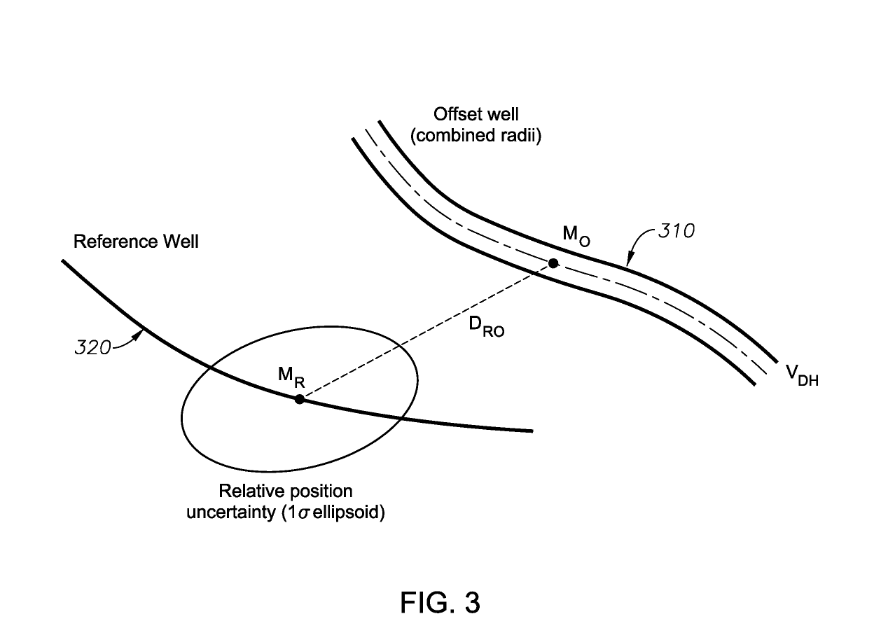

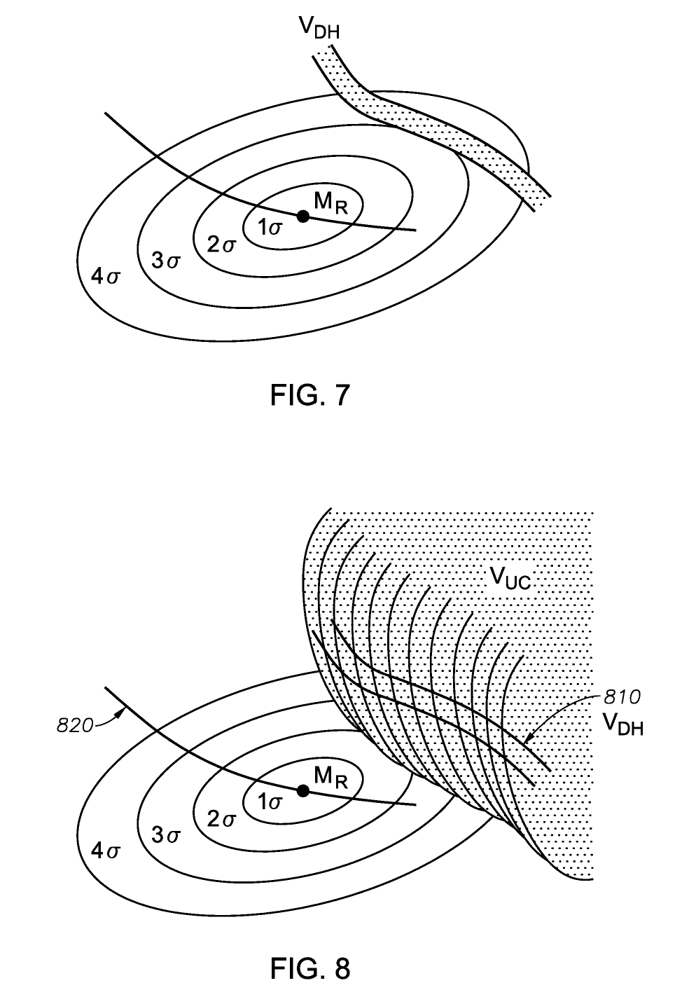

FIG. 3 illustrates a schematic diagram of a multiple wellbore environment in accordance with implementations of various techniques described herein. In particular, as shown, a reference wellbore section 320, having a reference wellbore point M_{R}, may be drilled in proximity to an offset wellbore section 310 having an offset wellbore point M_{O}, where the offset wellbore section 310 is represented by the volume V_{DH} with the combined radii of the two wellbore sections. Further, the combined uncertainty of the two wellbore sections is assigned to the reference wellbore point M_{R}, and is represented by a concentric ellipsoid with a 1σ confidence region. FIGS. 7 and 8 (described in greater detail in the Further Discussion section) illustrate similar scenarios, in which the combined uncertainty of the two wellbore sections is assigned to the reference wellbore point M_{R} and is represented by concentric ellipsoids of differing confidence regions.

As further described below, the one or more DH probabilities between a reference wellbore section and an offset wellbore section can be determined using the volume V_{DH} via the fundamental probability formula:

P(M_{R} inside V)=∫∫∫_{V}ƒ(3D)dV (1),

where ƒ(3D) is the 3D probability density distribution function (PDF) corresponding to the combined uncertainty, V corresponds to the volume V_{DH}, and P is the probability that the true position of M_{R} lies inside the volume V_{DH}. As is known in the art, uncertainty, including the combined uncertainty, may be represented by PDFs in 3D, 2D, or 1D. Any appropriate PDF known to those skilled in the art may be used in Equation 1. As also described in the implementations below, Equation 1 may also be assessed by dividing V_{DH} into a number of segments, evaluating the integral within each segment, and then summing the contributions from all segments.

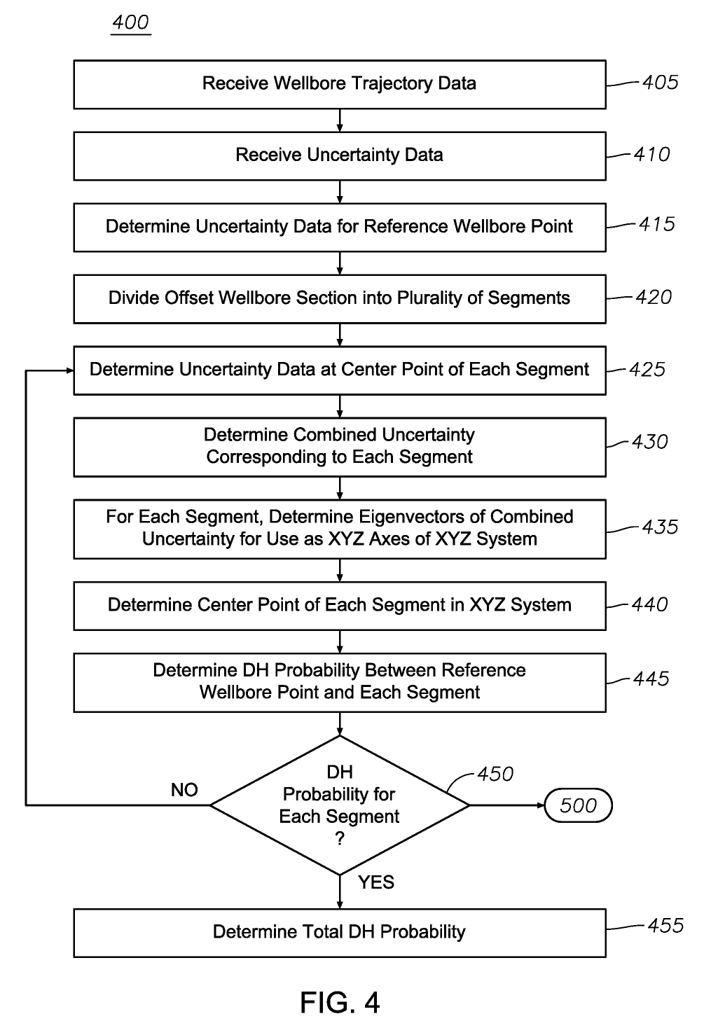

For example, FIG. 4 illustrates one implementation for determining one or more DH probabilities between a reference wellbore section and an offset wellbore section. In particular, FIG. 4 illustrates a flow diagram of a method 400 for determining one or more DH probabilities between an offset wellbore section and a reference wellbore point of a reference wellbore section in accordance with implementations of various techniques described herein. In one implementation, method 400 may be at least partially performed by a computing system, such as the computing system 130 discussed above. It should be understood that while method 400 indicates a particular order of execution of operations, in some implementations, certain portions of the operations might be executed in a different order. Further, in some implementations, additional operations or steps may be added to the method 400. Likewise, some operations or steps may be omitted.

For purposes of analysis, the reference wellbore point and reference wellbore section may be chosen anywhere along the reference wellbore, and the offset wellbore section may be chosen anywhere along the offset wellbore. The reference wellbore point may also sometimes be referred to as the analysis point.

At block 405, the computing system may receive wellbore trajectory data for a reference wellbore section and for an offset wellbore section. In one implementation, the wellbore trajectory data may include directional data and position data. Directional data may include data relating to measured depth (MD), inclination (I), and azimuth (A). In some implementations, the directional data may be available for survey stations and/or intervals throughout the reference wellbore section and the offset wellbore section. The directional data may have been obtained from one or more real surveys, such as surveys conducted using the survey tools discussed earlier, or from well and/or drilling plans.

Position data may include data relating to NEV coordinates of the reference wellbore section and the offset wellbore section. In some implementations, the directional data may be used to obtain the position data, such as by converting the directional data into nominal NEV coordinates at the same MD locations using techniques known to those skilled in the art. The trajectories for both wellbores may be centered on nominal NEV positions. In another implementation, the directional data and the position data can be interpolated to any MD in either the reference wellbore or the offset wellbore sections via any interpolation method known to those skilled in the art.

At block 410, the computing system may receive uncertainty data for the reference wellbore section and for the offset wellbore section. As noted above, uncertainty data may correspond to wellbore position uncertainties for the reference wellbore section and the offset wellbore section, where such uncertainties may be determined based on various methods and procedures, such as error models.

In particular, the uncertainty data may include wellbore position uncertainties for the reference wellbore section and the offset wellbore section, where the wellbore position uncertainties correspond to the same locations of the position data for both wellbore sections. In addition, the uncertainty data may also be represented by 3D covariance matrices given in the NEV coordinate system. Further, the uncertainty data may correspond to wellbore position uncertainties that include survey uncertainties from real or planned surveys evaluated by error models, surface position uncertainties, and/or other possible position uncertainties that may represent issues, such as the ability to drill or steer.

At block 415, the computing system may determine uncertainty data for the reference wellbore point (M_{R}) based on the received uncertainty data and the received wellbore trajectory data. In one implementation, the uncertainty data, such as when in covariance matrix format, can be interpolated to any MD in either the reference wellbore or the offset wellbore sections. As such, in some implementations, the uncertainty data for M_{R} may be determined based on an interpolation of the received uncertainty data and the received wellbore trajectory data.

At block 420, the computing system may divide the offset wellbore section into a plurality of segments based on the received wellbore trajectory data. In particular, the offset wellbore section may be divided into J segments, where J is an integer greater than one. A particular segment of these J segments may hereinafter be referred to as segment j, where j is an integer from 1 to J. Each segment j may also be centered on a point, which may hereinafter be referred to as center point j. Further, each segment j may be symmetrical about its center point j.

In addition, as similarly explained above, for each segment j, the cross-sectional dimensions of the offset wellbore section may be combined with the cross-sectional dimensions of the reference wellbore section, where the combined cross-sectional dimensions may be assigned to the offset wellbore section. For example, for implementations where the offset wellbore section and/or the reference wellbore section are cylindrical with elliptical cross-sections, a representative radius of the offset wellbore section at segment j may be combined with a representative radius of the reference wellbore section at the reference wellbore point M_{R}, taking into account the directions of both wellbore sections (e.g., an angle between a direction of the offset wellbore section at center point j and a direction of the reference wellbore section at the reference wellbore point. The combined radii may be assigned to the offset wellbore section. In other implementations, the offset wellbore section and/or the reference wellbore section may be non-cylindrical, and may have cross-sections that are non-elliptical.

Each of the J segments may have different lengths, or each of the J segments may have the same length L, where L may be set by a formula. The length of the J segments may be determined based on representative cross-sectional dimensions of the offset wellbore section and the reference wellbore section. In some implementations where the offset wellbore section and the reference wellbore section are cylindrical with elliptical cross-sections, the length L may be comparable in size to that of the representative radii R_{O} and R_{R}. In one implementation,

L=\sqrt{3}(R_{R}+R_{O}) (2),

where R_{R} represents a radius of the reference wellbore section, and R_{O} represents a radius of the offset wellbore section.

In some implementations where the representative radii R_{O} and R_{R} are combined and assigned to the offset wellbore section, the cross-section of each segment j may be elliptical, and the cross-section of each segment j may be described by the ellipse's principal radii R₁ and R₂, where

R₁=R_{O}+R_{R} (3),

R_{2,MR,j}=R_{O}+R_{R}|cos(β_{MR,j})|, (4),

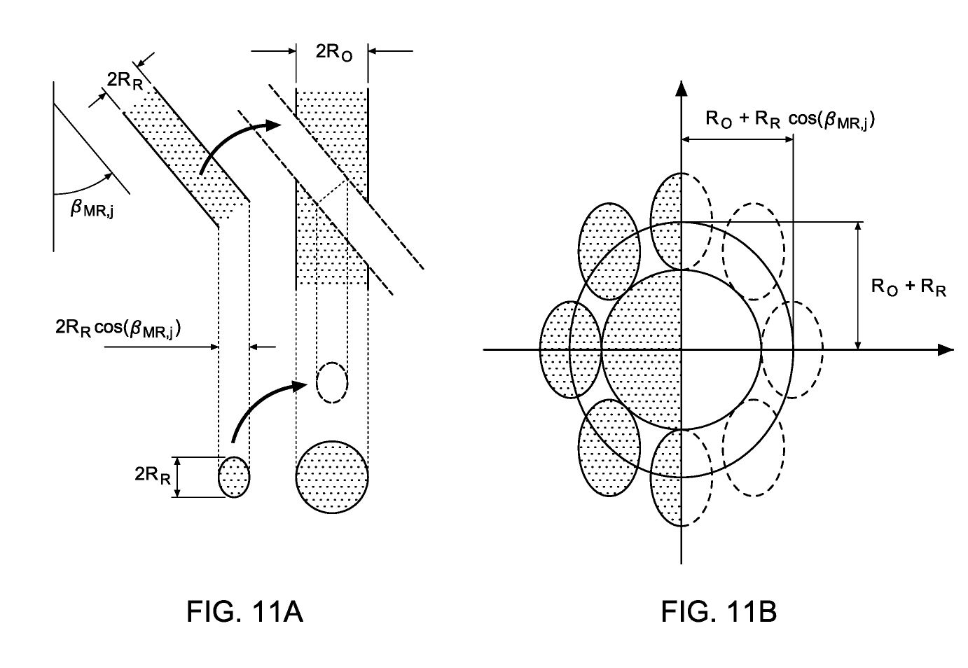

and where β_{MR,j} is an angle between a direction of the offset wellbore section at center point j and a direction of the reference wellbore section at the reference wellbore point, and cos(β_{MR,j}) is given by the inner product of the local tangent vectors. This is depicted in FIGS. 11A-11B, as described later in the Further Discussion section.

At block 425, the computing system may, for each segment j of the offset wellbore section, determine uncertainty data at center point j of the segment based on the received uncertainty data and the received wellbore trajectory data. In some implementations, the uncertainty data for the segment j may be determined based on an interpolation of the received uncertainty data, using wellbore trajectory data for the interpolation.

At block 430, the computing system may, for each segment j of the offset wellbore section, determine a combined uncertainty based on a combination of the uncertainty data for the reference wellbore point M_{R} and the uncertainty data of the center point j of the segment. In some implementations, the combined uncertainty for the segment j may be assigned to the reference wellbore point M_{R}.

At block 435, the computing system may, for each segment j of the offset wellbore section, determine the eigenvectors of the combined uncertainty for the segment j. In particular, the combined uncertainty for the segment j may be represented by a combined covariance matrix, which can be expressed as a combined EOU, as explained earlier. The eigenvectors of the combined EOU may be used as X, Y, and Z axes of an XYZ coordinate system, in which a 3D PDF of the combined uncertainty may be expressed. Any appropriate 3D PDF known to those skilled in the art may be used. Expressing the combined uncertainty in the XYZ system may separate the 3D PDF into the product of three 1D PDFs (f_{X}, f_{Y}, and f_{Z}):

f_{XYZ}=f_{X}*f_{Y}*f_{Z} (5).

In particular, ƒ_{X}, ƒ_{Y}, and ƒ_{Z} are the 1D PDFs along the principal axes of the combined EOU that express the relative uncertainty between the reference wellbore point M_{R} and the segment j. Any of f_{X}, f_{Y}, or f_{Z} may be a normal (Gaussian) distribution, or they may be similar distributions that may be relevant for describing the uncertainties.

At block 440, the computing system may, for each segment j of the offset wellbore section, determine the center point of the segment j in the XYZ system, which may be center point (xⱼ, yⱼ, zⱼ).

At block 445, the computing system may, for each segment j of the offset wellbore section, determine a DH probability between the reference wellbore point M_{R} and the segment j, using the center point (xⱼ, yⱼ, zⱼ). In one implementation, the DH probability (P_{DH}) between the reference wellbore point M_{R} and the segment j may be represented by the formula:

$${P}_{DH} ( {M}_{R} , j ) \approx {f}_{X} {f}_{Y} {f}_{Z} π {R}_{1} {R}_{2} L + [ {f}_{X}^{″} {f}_{Y} {f}_{Z} + {f}_{X} {f}_{Y}^{″} {f}_{Z} + {f}_{X} {f}_{Y} {f}_{Z}^{″} ] \frac{π}{8} {R}_{1}^{4} L , \qquad ( 6 )$$

where ƒ_{X}, ƒ_{Y}, ƒ_{Z}, R₁, R₂, and L have been defined above, and the second derivatives ƒ_{X}″, ƒ_{Y}″, and ƒ_{Z}″ may be evaluated at the segment's center point (xⱼ, yⱼ, zⱼ) using PDFs with the respective standard deviations σ_{X}, σ_{Y}, and σ_{Z}, where

$${f}_{X}^{″} = \frac{{\partial }^{2} {f}_{X}}{\partial {x}^{2}} , {f}_{Y}^{″} = \frac{{\partial }^{2} {f}_{Y}}{\partial {y}^{2}} , and {f}_{Z}^{″} = \frac{{\partial }^{2} {f}_{Z}}{\partial {z}^{2}} .$$

For implementations where the offset wellbore section and/or the reference wellbore section may be non-cylindrical with cross-sections that are non-elliptical, the combined cross-sectional dimensions may be used in place of R₁ and R₂.

As noted above, the combined uncertainty in the XYZ system may separate the 3D PDF into the product of three 1D PDFs. The 3D PDF may be expanded into a Taylor series around the center of segment j: f_{XYZ}=f_{XYZ0}+a₁f_{XYZ1}+a₂f_{XYZ2}+a₃f_{XYZ3}+ . . . , where aₙ is the Taylor coefficient, and f_{XYZn} is the n'th derivative of f_{XYZ}, for Taylor term n. The integral of the total PDF (f_{XYZ}) over the volume of segment j may yield the total DH probability P_{DH}(M_{R,j}) between point M_{R} and segment j. Similarly, the integral of the n'th term aₙf_{XYZn} of the Taylor series may give the contribution Pₙ to P_{DH}(M_{R,j}). The contribution P₀ may be the PDF's value at the center of segment j, multiplied by the segment's volume. This term may be used as an estimate for P_{DH}(M_{R,j}) However, the terms Pₙ for n>=1 may act as corrections to P₀, and may therefore improve the accuracy of the P_{DH}(M_{R,j}) estimate when they are included.

Because of the symmetry of each of segment j, the contributions of all odd-numbered terms of the Taylor series (n=1, 3, 5 . . . ) vanishes when the term is integrated over the segment's volume. Because of the formula for the segment's length L described above, the approximation to P₂ may be considered to be optimal, in the sense that it is considered to give the most accurate analytic estimate of P₂. The derivation may result in an estimate of the DH probability P_{DH}(M_{R,j}) between point M_{R} and segment j that can be written P_{DH}(M_{R,j})=P₀+P₂, which is shown in Equation 6. In effect, the second order term P₂ may be used as a correction to the used term P₀, where P₂ may represent an integral of the second order Taylor series term. Implementations for P_{DH}(M_{R,j}) are described in greater detail in the Further Discussion section.

At block 450, the computing system may determine if a DH probability has been determined between the reference wellbore point M_{R} and each segment j of the J segments. If not, the computing system may loop back to block 425 to repeat blocks 425-445 for the remaining segments. If a DH probability has been determined for each of the J segments, then the method may proceed to block 455.

At block 455, the computing system may determine a total DH probability between the reference wellbore point M_{R} and all of the J segments of the offset wellbore section by summing the DH probabilities for the J segments. This total DH probability may represent the probability that the reference wellbore point M_{R} intersects at any position along the offset wellbore section.

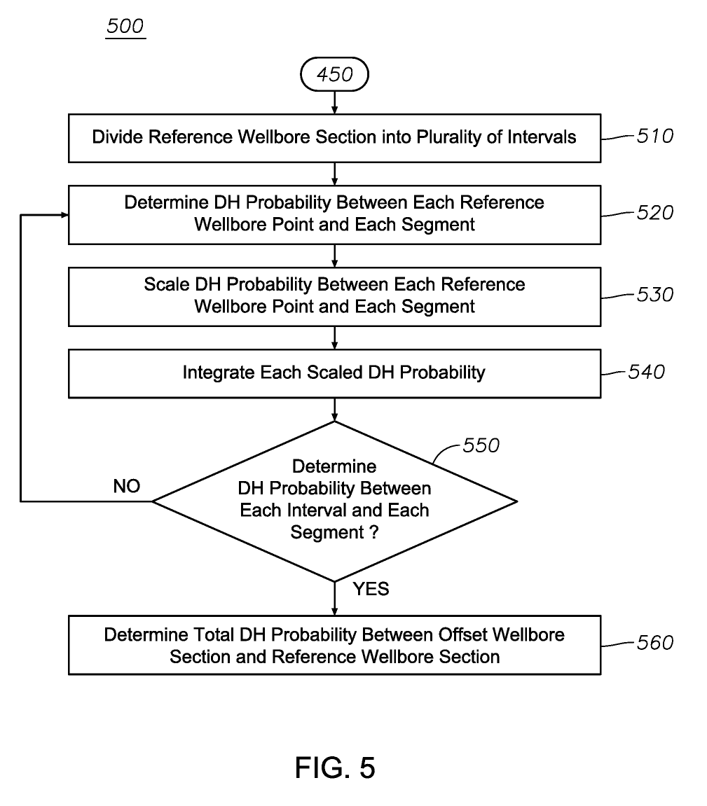

As also shown in FIG. 4, if a DH probability has been determined for each of the J segments at block 450, the method may also continue to method 500. FIG. 5 illustrates a flow diagram of a method 500 for determining one or more DH probabilities between the reference wellbore section and the offset wellbore section in accordance with implementations of various techniques described herein. In one implementation, method 500 may be at least partially performed by a computing system, such as the computing system 130 discussed above. It should be understood that while method 500 indicates a particular order of execution of operations, in some implementations, certain portions of the operations might be executed in a different order. Further, in some implementations, additional operations or steps may be added to the method 500. Likewise, some operations or steps may be omitted.

At block 510, the computing system may divide the reference wellbore section into a plurality of intervals based on the received wellbore trajectory data and a plurality of reference wellbore points of the reference wellbore section. In particular, a plurality of reference wellbore points (including the reference wellbore point M_{R} discussed with respect to FIG. 4) may be defined within the reference wellbore section, where the reference wellbore points may be spaced from one another along the reference wellbore section at constant or varying lengths. Each pair of adjacent reference wellbore points forms an interval along the reference wellbore section, with a reference wellbore point positioned at each end of the interval. As such, the plurality of intervals is formed based on the placement of the plurality of reference wellbore points along the reference wellbore section. The plurality of intervals may also sometimes be referred to herein as analysis intervals.

In one implementation, the reference wellbore section may be divided into M−1 intervals by M number of reference wellbore points M_{R}(1), M_{R}(2), . . . M_{R}(M), where M is an integer greater than 1. A particular reference wellbore point of these M reference wellbore points may hereinafter be referred to as M_{R}(m), where m is an integer from 1 to M.

At block 520, the computing system may, for each reference wellbore point, determine a DH probability between the reference wellbore point and each of the J segments of the offset wellbore section, using the method 400 described above with respect to FIG. 4. In particular, a DH probability may be determined between each of the J segments and each of the reference wellbore points M_{R}(1), M_{R}(2), . . . M_{R}(M). In some implementations, Equation 6 described with respect to block 445 may be used to determine the DH probability between each of the M reference wellbore points and each of the J segments. The DH probability between a particular reference wellbore point M_{R}(m) and a particular segment j may hereinafter be denoted as P_{DH}(M_{R}(m),j).

At block 530, the computing system may, for each reference wellbore point and each segment in the offset wellbore section, scale the DH probability such that it relates to a common along-hole coordinate, where the along-hole coordinate corresponds to the reference wellbore section. In particular, for each reference wellbore point M_{R}(m) in the reference wellbore section and each segment j in the offset wellbore section, the DH probability P_{DH}(M_{R}(m),j) between M_{R}(m) and segment j may be divided by the respective volume Vj(m) of segment j. The volume Vj(m) of segment j may be a function of the location of point M_{R}(m) in the reference wellbore section, because the volume may depend on the angle β_{MR,j} (discussed with respect to FIG. 4) between the local tangents of the two wellbore sections. The result of the division may be a local PDF f(M_{R}(m),j) that may be valid with respect to reference wellbore point M_{R}(m), across segment j.

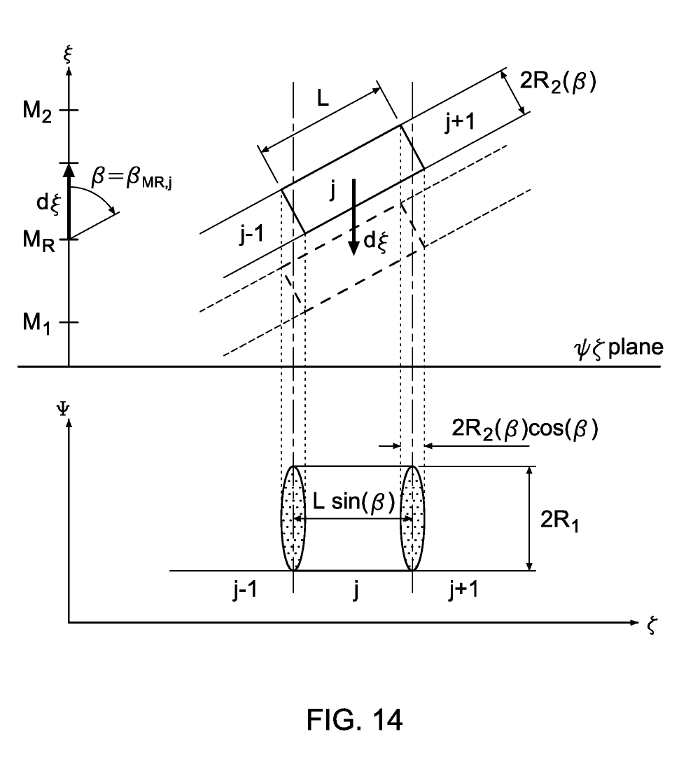

For example, as illustrated in FIG. 14 (described later in the Further Discussion section), for one point M_{R} in the reference wellbore section, consider the local ξψζ system, where ξ is the along-hole coordinate, and ψ and ζ are coordinates defining a plane that is perpendicular to ξ. Viewed along the ξ axis, segment j may be seen projected onto the ψζ plane, with projected height 2R₁ and projected width L sin(β_{MR,j}). Any overlap with segment j−1 or segment j+1 is excluded. When drilling the short distance dξ, the probability of hitting segment j may be:

dP_{DH,dξ}(j)=ƒ̅_{MR}(j)dV=(P_{DH,MR}(j)/V_{MR}(j))2R₁L sin(β_{MR,j})dξ (7)

where the ratio between P_{DH,MR}(j) and V_{MR}(j) becomes an average PDF value ƒ̅_{MR}(j) that is valid across segment j. Both P_{DH,MR}(j) and V_{MR}(j) may vary with ξ through their dependency on the local angle β_{MR,j}(ξ).

At block 540, the computing system may, for each reference wellbore point and each segment in the offset wellbore section, integrate the scaled DH probability along the along-hole coordinate. In particular, for each reference wellbore point M_{R}(m), the local PDF value f(M_{R}(m),j) may be converted back into a probability, through multiplication by the volume V′j(m). V′j(m) represents a thin slice of thickness dξ of the original volume Vj(m). The orientation of the slice may be such that its thickness may be measured along the local direction of the reference wellbore section at point M_{R}(m). Hence, the cross-section dimensions of the slice with volume V′j(m) may be the cross-section dimensions of segment j, when segment j is viewed in the reference wellbore section along-hole direction at M_{R}(m).

Dividing P_{DH}(M_{R}(m),j) by Vj(m) and then multiplying by V′j(m) may lead to a resulting expression that becomes, to a good approximation, a function of the reference wellbore section along-hole coordinate (ξ) only. This coordinate may replace the index m of point M_{R}(m). Hence, the probability of hitting segment j when drilling a short distance of the reference wellbore section may be obtained by integrating the expression P_{DH}(M_{R}(ξ),j)*V′j(ξ)/Vj(ξ) in 1D (i.e., along the reference wellbore section's along-hole direction). When this is done in small steps, such as over the short distance between two consecutive analysis points M_{R}(m) and M_{R}(m+1), the integral can be approximated by the area of a trapezoid. For example, DH probability over an analysis interval defined by reference wellbore points M₁ and M₂ may be equal to:

$${P}_{DH , M 1 M 2} ( j ) \approx 2 {R}_{1} L [ \frac{{P}_{DH , M 1} ( j ) sin ( {β}_{M 1 , j} )}{{V}_{M 1} ( j )} + \frac{{P}_{DH , M 2} ( j ) sin ( {β}_{M 2 , j} )}{{V}_{M 2} ( j )} ] ( Δ {MD}_{M 1 M 2} / 2 ) \qquad ( 8 )$$

where β_{M,j} is the angle between the local wellbore tangents in reference wellbore point M and segment j. As such, Equation 8 may be used to determine a DH probability of hitting segment j of the offset wellbore section when drilling along an analysis interval of the reference wellbore section (e.g., the interval between points M₁ and M₂).

At block 550, the computing system may determine if a DH probability has been determined for each analysis interval of the reference wellbore section and each segment of the offset wellbore section. In particular, the computing system may determine if a DH probability has been determined for each analysis interval from 1 thru M−1 and for each segment j of the J segments. If not, the computing system may loop back to block 520 to repeat blocks 520-540 for the remaining segments, reference wellbore points, and analysis intervals. If it is determined that a DH probability has been determined between each analysis interval of the reference wellbore section and each segment of the offset wellbore section, then the method may proceed to block 560.

At block 560, the computing system may determine a total DH probability between the reference wellbore section and the offset wellbore section by summing the DH probabilities (determined at block 550) for all of the segments and analysis intervals. The total DH probability may represent the probability that the reference wellbore section intersects at any position along the offset wellbore section.

The implementations described above may be used to determine one or more DH probabilities between a reference wellbore and an offset wellbore. In particular, these implementations may be used to determine one or more DH probabilities between an offset wellbore section and a reference wellbore point of a reference wellbore section, or to determine one or more DH probabilities between an offset wellbore section and a reference wellbore section. As mentioned above, a drilling operator may use these determined DH probabilities when making decisions on whether to follow or alter a drilling plan, as a direct hit event between the reference and offset wellbores may lead to significant economic, environmental, and health and safety consequences. Additional details regarding the methods for determining the one or more DH probabilities between a reference wellbore and an offset wellbore are described in the Further Discussion section.

### Unintentional Crossing (UC) Probability

One or more methods may be used to determine one or more UC probabilities between a reference wellbore and an offset wellbore. In particular, the one or more UC probabilities may be determined at various points and/or intervals along each wellbore. As noted above, a UC probability may be defined as a probability of an unintentional crossing event occurring between a reference wellbore and an offset wellbore, and an unintentional crossing event between the wellbores may refer to instances where the reference wellbore inadvertently traverses into a region proximate to the offset wellbore that the reference wellbore is planned to avoid. Such a region may encompass the offset wellbore. In one implementation, the region may be represented by a volume that is approximately bounded by a surface of the offset wellbore that faces the reference wellbore, and the volume may extend in a direction beyond the offset wellbore section and away from the reference wellbore, when viewed from the reference wellbore. In such an implementation, for an unintentional crossing event, the reference wellbore is considered to have “crossed” the offset wellbore once it has traversed into this region, such as by crossing a boundary of the region (e.g., the surface of the offset wellbore that faces the reference wellbore).

As further described below, the one or more UC probabilities may be determined based on uncertainty data for the reference wellbore section and on uncertainty data for the offset wellbore section. The uncertainty data may be similar to the uncertainty data described above with respect to DH probabilities. In particular, as described above, the uncertainty data may be determined at several locations down each wellbore, such as at each survey station. In addition, the uncertainty data may be determined based on various methods and procedures, such as error models.

At each such location, the determined uncertainty data may be represented mathematically by a covariance matrix. The covariance matrix may be similar to the covariance matrix described above with respect to DH probabilities. In addition, as similarly described above, for the uncertainty data at a particular location in a wellbore, the confidence region of the wellbore position uncertainty may be represented by an ellipsoid or ellipse (i.e., EOU). The EOU may be similar to the EOU described above with respect to DH probabilities.

As further described below, to facilitate the determinations of one or more UC probabilities between a reference wellbore section and an offset wellbore section based on the uncertainty data, a point pair (i.e., one point in each wellbore) may be considered, the uncertainties at these points may be combined, and the combined uncertainty may be assigned to the reference wellbore section. The combined uncertainty may be expressed by a 3D covariance matrix, which may be analogous to the individual covariance matrices of the respective points.

In addition, the cross-sectional dimensions (e.g., radii) of the offset and reference wellbore sections may be combined, and the combined cross-sectional dimensions (e.g., radii) may be assigned to the offset wellbore section. As noted above, the volume of the offset wellbore section with the combined cross-sectional dimensions (e.g., radii) may be labeled as V_{DH}, where the volume may represent a tubular, “unwanted” region that the reference wellbore is to avoid.

Further, in determining the UC probabilities, a V_{UC} may be used to represent an “unwanted” region proximate to the offset wellbore section that the reference wellbore is to avoid. The volume V_{UC} may include the offset wellbore section and some extended region proximate to the offset wellbore section. However, in contrast with the volume V_{DH}, the volume V_{UC} may be realized with a variety of shapes. In one implementation, the volume V_{UC} may include a volume that is approximately bounded by a surface of the offset wellbore section that faces the reference wellbore section, and the volume may extend in a direction beyond the offset wellbore section and away from the reference wellbore section, when viewed from the reference wellbore section.

For example, FIG. 8 (described in greater detail in the Further Discussion section) illustrates a schematic diagram of a multiple wellbore environment in accordance with implementations of various techniques described herein. In particular, as shown, a reference wellbore section 820, with a reference wellbore point M_{R}, may be drilled in proximity to an offset wellbore section 810, as represented by a volume V_{DH} with the combined radii of the two wellbores. The “unwanted” region proximate to the offset wellbore section 810 that the reference wellbore section 820 is to avoid is represented by the volume V_{UC}, where the volume V_{UC} is shown as encompassing the offset wellbore section 810. As shown in FIG. 8, the volume V_{UC} may be approximately bounded by the surface of the offset wellbore section 810 that faces the reference wellbore section 820, and the volume extends in a direction beyond the offset wellbore section 810 and away from the reference wellbore section 820, when viewed from the reference wellbore section 820. Further, the combined uncertainty of the two wellbore sections is represented by the concentric ellipsoids of differing confidence regions assigned to the reference wellbore point M_{R}.

For such an implementation, and as further described below, the one or more UC probabilities between a reference wellbore section and an offset wellbore section can be determined using the volume V_{UC} via the fundamental probability formula described by Equation 1, which is repeated again here:

P(M_{R} inside V)=∫∫∫_{V}ƒ(3D)dV (1),

where ƒ(3D) is the 3D PDF corresponding to the combined uncertainty, V corresponds to the volume V_{UC}, and P is the probability that the true position of the reference wellbore point M_{R} is disposed within the volume V_{UC}, and therefore represents the probability that the reference wellbore point M_{R} has “crossed” the offset wellbore section. As is known in the art, uncertainty, including the combined uncertainty, may be represented by PDFs in 3D, 2D, or 1D. Any appropriate PDF known to those skilled in the art may be used in Equation 1. As also described in the implementations below, Equation 1 may also be assessed by dividing V_{UC} into a number of small volumes (e.g., wedge-shaped volumes), evaluating the integral within each small volume, and then summing the contributions from all of the small volumes.

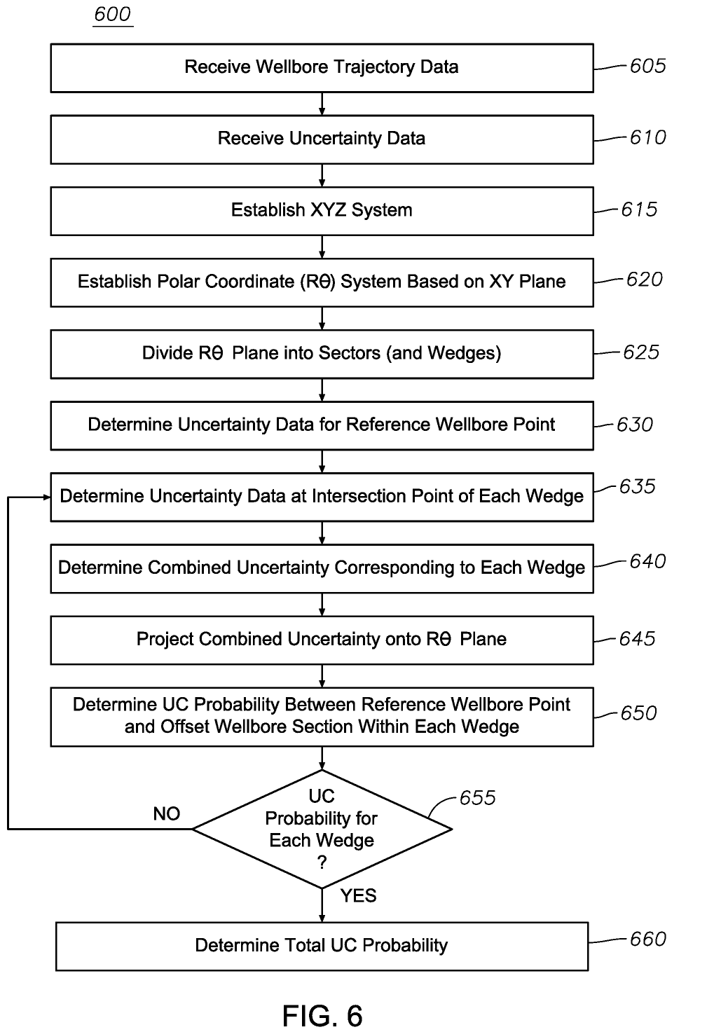

For example, FIG. 6 illustrates one implementation for determining one or more UC probabilities between a reference wellbore section and an offset wellbore section. In particular, FIG. 6 illustrates a flow diagram of a method 600 for determining one or more UC probabilities between an offset wellbore section and a reference wellbore point of a reference wellbore section in accordance with implementations of various techniques described herein. In one implementation, method 600 may be at least partially performed by a computing system, such as the computing system 130 discussed above. It should be understood that while method 600 indicates a particular order of execution of operations, in some implementations, certain portions of the operations might be executed in a different order. Further, in some implementations, additional operations or steps may be added to the method 600. Likewise, some operations or steps may be omitted.

For purposes of analysis, the reference wellbore point and reference wellbore section may be chosen anywhere along the reference wellbore, and the offset wellbore section may be chosen anywhere along the offset wellbore. The reference wellbore point may also sometimes be referred to as the analysis point.

At block 605, the computing system may receive wellbore trajectory data for a reference wellbore section and for an offset wellbore section. In one implementation, the wellbore trajectory data may include directional data and position data. Directional data may include data relating to measured depth (MD), inclination (I), and azimuth (A). In some implementations, the directional data may be available for survey stations and/or intervals throughout the reference wellbore section and the offset wellbore section. The directional data may have been obtained from one or more real surveys, such as surveys conducted using the survey tools discussed earlier, or from well and/or drilling plans.

Position data may include data relating to NEV coordinates of the reference wellbore section and the offset wellbore section. In some implementations, the directional data may be used to obtain the position data, such as by converting the directional data into nominal NEV coordinates at the same MD locations using techniques known to those skilled in the art. The trajectories for both wellbores may be centered on nominal NEV positions. In another implementation, the directional data and the position data can be interpolated to any MD in either of the reference wellbore or the offset wellbore sections via any interpolation method known to those skilled in the art.

At block 610, the computing system may receive uncertainty data for the reference wellbore section and for the offset wellbore section. As noted above, uncertainty data may correspond to wellbore position uncertainties for the reference wellbore section and the offset wellbore section, where such uncertainties may be determined based on various methods and procedures known to those skilled in the art, such as error models.

In particular, the uncertainty data may include wellbore position uncertainties for the reference wellbore section and the offset wellbore section, where the wellbore position uncertainties correspond to the same locations of the position data for both wellbore sections. In addition, the uncertainty data may also be represented by 3D covariance matrices given in the NEV coordinate system. Further, the uncertainty data may correspond to wellbore position uncertainties that include survey uncertainties from real or planned surveys evaluated by error models, surface position uncertainties, and/or other possible position uncertainties that may represent issues, such as the ability to drill or steer.

At block 615, the computing system may establish a Cartesian (XYZ) coordinate system based on the reference wellbore point (M_{R}) and the offset wellbore section. In one implementation, the XYZ coordinate system may be established based on the predominating direction of the offset wellbore section, or a smaller part of the section, and the position of the reference wellbore point M_{R}. The XYZ system may be established such that the Y axis is parallel to the predominant direction of the offset wellbore section, the X axis points from the reference wellbore point M_{R} perpendicularly onto the predominant direction of the offset wellbore section, and the origin is at reference wellbore point M_{R}. Through this definition of the XYZ system, the offset wellbore section may lie close to the XY plane. Further, the offset wellbore section may then be projected onto the XY plane.

At block 620, the computing system may establish a polar coordinate (RO) system based on the XY plane of the XYZ coordinate system. In particular, the XY plane may be converted into a polar coordinate (RΘ) system (i.e., an RΘ plane) having the same origin as the XY system, where R is the radial axis (and along the X axis) and Θ is the angular direction. Further, the conversion of the XY plane into RΘ polar coordinates implies a conversion of the Cartesian XYZ system into a cylindrical RΘZ coordinate system. The RΘZ system may have the same Z axis and origin as the XYZ system. As such, the representation of the offset wellbore section in the XYZ system may be converted to a representation of the offset wellbore section in the RΘZ system, and the representation of the projected offset wellbore section in the XY plane may be converted to a representation of the projected offset wellbore section in the RΘ plane.

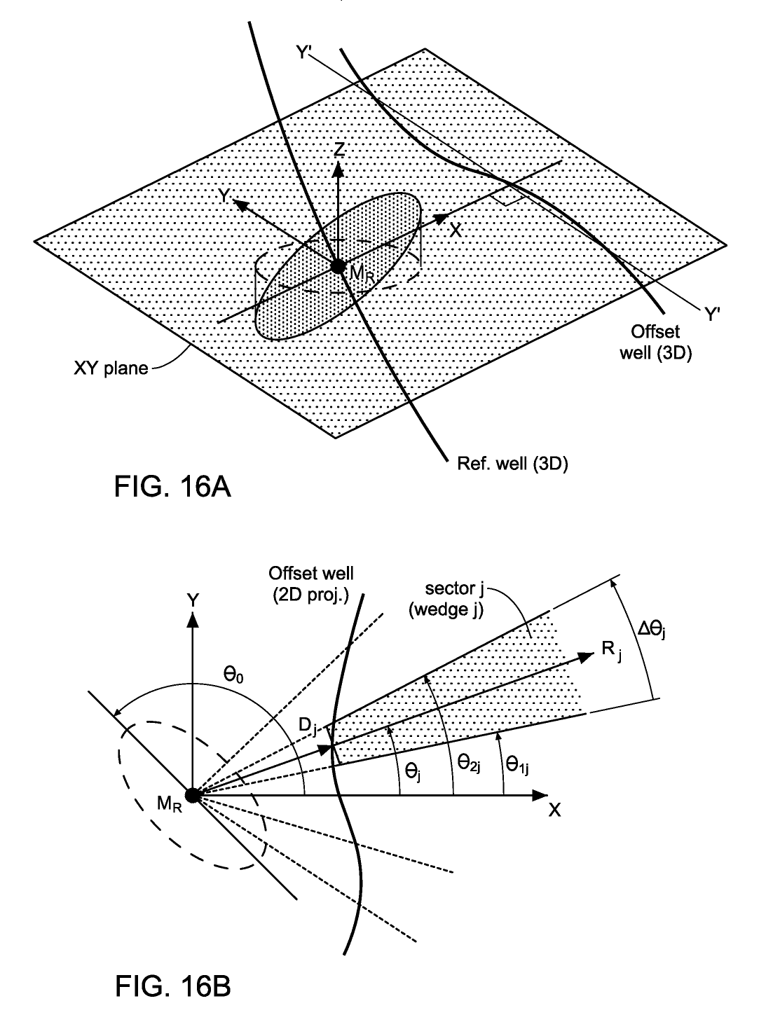

At block 625, the computing system may divide the RΘ plane into a plurality of sectors based on the reference wellbore point M_{R} and the offset wellbore section. In particular, the RΘ plane may be divided into J sectors, where J is an integer greater than one. A particular sector of these J sectors may hereinafter be referred to as sector j, where j is an integer from 1 to J. The J sectors may have opening angles Δθj corresponding to each sector j. All of the J sectors may emanate from the common origin, which is the reference wellbore point M_{R}. The Δθj may vary between the sectors, or a constant value may be used such that Δθj=Δθ₀ (e.g., Δθ₀=0.1 degrees, or Δθ₀=0.5 degrees). The direction and total number J of the sectors may be chosen such that the J sectors cover the total offset wellbore section after this section has been projected onto the RΘ plane. The parts of the RΘ plane that are not covered by the J sectors may be ignored. The RΘ plane with the plurality of sectors is shown in FIGS. 16A-16B, which is described in greater detail in the Further Discussion section.

Further, the division of the RΘ plane into J sectors may imply a division of the volume described in the RΘZ coordinate system into J wedges. A particular wedge of these J wedges may hereinafter be referred to as wedge j, where, again, j is an integer from 1 to J. The wedges may be chosen such that the Z axis of the RΘZ system is a common edge for all wedges, and such that sector j in the RΘ plane is the projection onto the RΘ plane of wedge j. Like the J sectors, the J wedges may have opening angles Δθj corresponding to each wedge, with all wedges originating from the Z axis. The parts of the RΘZ system that are not covered by the J wedges may be ignored. Through this definition of the RΘZ system, the offset wellbore section may intersect the wedges at nearly perpendicular angles for those wedges where the offset wellbore section lies closest to the reference wellbore point M_{R}. The offset wellbore section may also intersect the wedges at more oblique angles for those wedges where the offset wellbore section lies farther from the reference wellbore point M_{R}. The volume V_{UC} may be disposed within the plurality of wedges.

At block 630, the computing system may determine uncertainty data for the reference wellbore point M_{R} based on the received uncertainty data and the received wellbore trajectory data. In one implementation, the uncertainty data, such as when in covariance matrix format, can be interpolated to any MD in either of the reference wellbore or the offset wellbore section. As such, in some implementations, the uncertainty data for M_{R} may be determined based on an interpolation of the received uncertainty data and the received wellbore trajectory data.

At block 635, the computing system may, for each wedge j, determine uncertainty data at an intersection point (x₁, yⱼ, zⱼ) where the offset wellbore section intersects the central RⱼZ plane of the wedge j. The RⱼZ plane may be defined by the Z axis and an Rj axis that bisects sector j having angle Δθⱼ. This is also shown in FIGS. 16A-16B. The uncertainty data at the intersection point (xⱼ, yⱼ, zⱼ) may be determined based on the received uncertainty data and the received wellbore trajectory data. Further, in some implementations, the uncertainty data for the intersection point (xⱼ, yⱼ, zⱼ) may be determined based on an interpolation of the received uncertainty data and the received wellbore trajectory data.

At block 640, the computing system may, for each wedge j, determine a combined uncertainty based on a combination of the uncertainty data for the reference wellbore point M_{R} and the uncertainty data for the intersection point (xⱼ, yⱼ, zⱼ). In one implementation, the combined uncertainty may be expressed in the NEV system. This combined uncertainty may be assigned to the reference wellbore point M_{R}, converted to the XYZ system, and projected onto the XY plane.

At block 645, the computing system may project the combined uncertainty from the XY plane onto the RΘ plane. In another implementation, blocks 645 and 650 may be interchangeable, such that the uncertainty data for the reference wellbore point M_{R} and the uncertainty data for the intersection point (xⱼ, yⱼ, zⱼ) may be projected onto the RΘ plane prior to being combined.

At block 650, the computing system may, for each sector j and wedge j, determine a UC probability between the reference wellbore point M_{R} and the offset wellbore section that lies within sector j or wedge j, based on the projected combined uncertainty. In particular, the computing system may, for each sector j, evaluate a 2D PDF based on the combined uncertainty.

As an approximation that is accurate within each sector (and wedge), the 2D PDF in the RΘ plane can be separated into the product of two 1D PDFs: f_{RΘ}=f_{R}*f_{Θ}. Hence, the integral of the 2D PDF within each sector may be approximated by the product of two 1D integrals: one in the radial direction Rj, and one in the angular direction Θ. Any appropriate 2D PDF or 1D PDFs known to those skilled in the art may be used.

The radial integral may be determined over the r coordinate from the Rj distance of the intersection point (xⱼ, yⱼ, zⱼ) of the offset wellbore section with the RjZ plane, to infinity. This implies a boundary for the volume V_{UC}, as further described below. The angular direction integral may be determined over the θ coordinate over each sector j of opening angle Δθj.

Because of the initial projection of the combined uncertainty onto the 2D XY plane, the probability results obtained in this plane may be equally valid at any point along the Z axis. This means that the probability calculated within each 2D sector j in the plane may be valid for the corresponding 3D wedge j. The results of the two integrations may be multiplied together, thus producing the UC probability P_{UC}(j) between the reference wellbore point M_{R} and the offset wellbore section within wedge j. The probability P_{UC}(j) represents the probability that the reference wellbore point M_{R} has crossed a boundary for the volume V_{UC} within wedge j, and has therefore “crossed” the offset wellbore section within wedge j.

At block 655, the computing system may determine if a UC probability P_{UC}(j) has been determined between the reference wellbore point M_{R} and the offset wellbore section within each wedge j of the J wedges. If not, the computing system may loop back to block 635 to repeat blocks 635-650 for the remaining wedges. If a UC probability P_{UC}(j) has been determined for each of the J wedges, then the method may proceeds to block 660.

At block 660, the computing system may determine a total UC probability between the reference wellbore point M_{R} and the offset wellbore section within all of the J wedges by summing the UC probabilities P_{UC}(j) for the J wedges. This total UC probability may represent the probability that the reference wellbore point M_{R} has “crossed” the offset wellbore section within the J wedges (i.e., the probability that the reference wellbore point M_{R} has crossed a boundary for the volume V_{UC} within the J wedges).

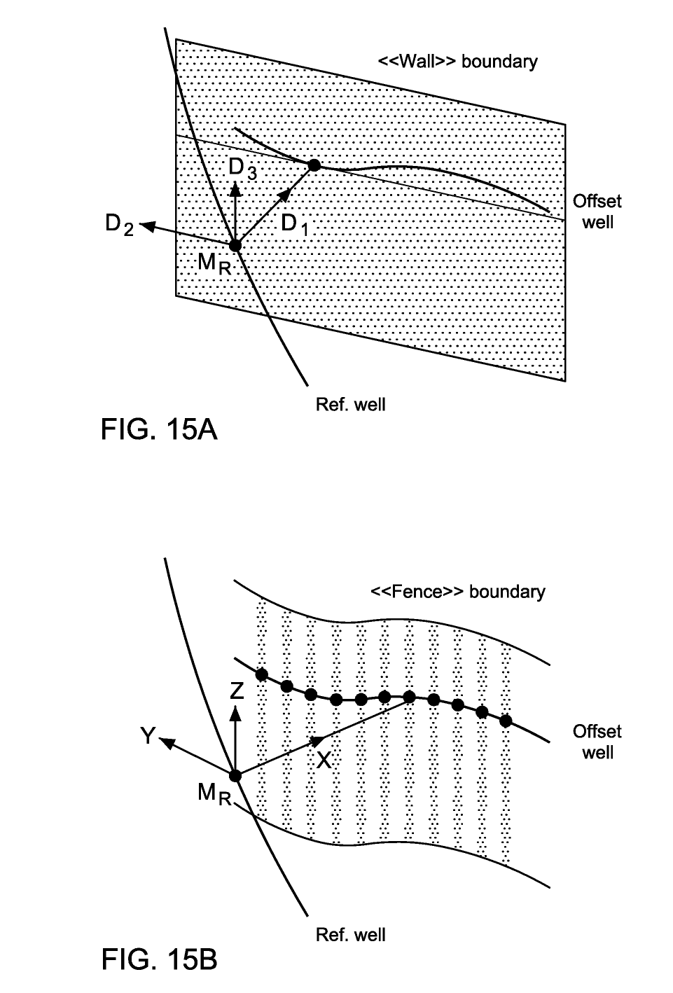

The method described above for determining one or more UC probabilities may imply an inherent definition of the boundary for V_{UC} (i.e., the “wrong side” volume). As noted above, the volume V_{UC} may include a volume that is approximately bounded by the offset wellbore surface that faces the reference wellbore section, and the volume may extend in a direction beyond the offset wellbore section and away from the reference wellbore section, when viewed from the reference wellbore section. The boundary may be made up of narrow bands (or “bars”) that are parallel to the Z axis. The bands may include one band within each wedge j, and may be disposed from the Z axis at a same distance as that of the intersection point (xⱼ, yⱼ, zⱼ). Due to the narrow opening angles of the wedges, the bands may virtually produce a continuous boundary (i.e., a “fence”) that follows the curvatures of the offset wellbore section. The method described here may therefore be assumed to give an accurate estimate for UC probabilities for scenarios involving curved wellbores, particularly when compared to methods used in the prior art. The narrow bands and the continuous boundary are shown in FIGS. 15A-15B, which is described in greater detail in the Further Discussion section.

In another implementation, a UC probability may be determined regarding whether the reference wellbore point M_{R} crosses “above” the offset wellbore section versus “below” the offset wellbore section within a wedge j. In particular, such probabilities may be determined by projecting the combined 3D EOU onto the RjZ plane (similar to the projection onto the RΘ plane performed with respect to FIG. 6) and evaluating the probability integrals in the RjZ plane (similar to the evaluations in the RΘ plane performed with respect to FIG. 6). These probabilities can be summed over all of the J wedges to determine a total UC probability that reference wellbore point M_{R} crosses “above” versus “below” the offset wellbore section within the J wedges. Such implementations are described in greater detail with respect to FIG. 18 in the Further Discussion section.

In one such implementation, an intersection point may be found between the 3D offset wellbore section and the RⱼZ plane. For the half plane where Rⱼ>0, the RⱼZ plane is divided into two by a straight line through reference wellbore point M_{R} and the intersection point (xⱼ, yⱼ, zⱼ). The two regions may be denoted as above and below the offset wellbore section. The RⱼZ plane may be divided into a total of H sectors by a polar coordinate system Sϕ, where one of the division lines should coincide with the line through M_{R} and the intersection point, where H is an integer greater than 1. Each of the H sectors in the RⱼZ (Sϕ) plane may be referred to as sector h, with h being an integer from 1 to H.

For each wedge j described in method 600 and the bisecting plane RⱼZ of wedge j, the uncertainty data for the reference wellbore point M_{R} and for the intersection point (xⱼ, yⱼ, zⱼ) may be combined and projected onto the RⱼZ (Sϕ) plane. The combined and projected uncertainty data may be expressed in the polar coordinates s, ϕ of the Sϕ system. For each sector h above the line through M_{R} and the intersection point, a 2D PDF may be evaluated based on the combined uncertainty, as similarly done in method 600. However, only the angular integral of the PDF (over ϕ) needs to be performed, because the radial integral (over s) runs from zero to infinity, thereby yielding the same value for each of the H sectors. The results may be summed to obtain a probability in the RⱼZ plane of being above the line through M_{R} and the intersection point in the RⱼZ plane of wedge j. Similarly, for each sector h below the line through M_{R} and the intersection point, a 2D PDF may be evaluated based on the combined uncertainty, as similarly done in method 600. However, only the angular integral of the PDF (over ϕ) needs to be performed, because the radial integral (over s) runs from zero to infinity, thereby yielding the same value for each of the H sectors. The results may be summed to obtain a probability in the RⱼZ plane of being below the line through M_{R} and the intersection point in the RⱼZ plane of wedge j. Furthermore, the probability in the RⱼZ plane of being above the line through M_{R} and the intersection point in the RⱼZ plane of wedge j and the probability in the RⱼZ plane of being below the line through M_{R} and the intersection point in the RⱼZ plane of wedge j may each be normalized by dividing each of these probabilities by the sum of these probabilities. The resulting normalized probabilities (i.e., with values between 0 and 1) may represent a normalized probability in the RⱼZ plane of being above the line through M_{R} and the intersection point in the RⱼZ plane of wedge j and a normalized probability in the RⱼZ plane of being below the line through M_{R} and the intersection point in the RⱼZ plane of wedge j. The probabilities (or normalized probabilities) in the RⱼZ plane of being above the line through M_{R} and the intersection point in the RⱼZ plane of wedge j may be summed over all J wedges to give a total probability that the reference wellbore point M_{R} has crossed above the offset wellbore section within any of the J wedges. Similarly, the probabilities (or normalized probabilities) in the RⱼZ plane of being below the line through M_{R} and the intersection point in the RⱼZ plane of wedge j may be summed over all J wedges to give a total probability that the reference wellbore point M_{R} has crossed below the offset wellbore section within any of the J wedges.

In yet another implementation, an XZ plane may be used as the analysis plane in method 600, as opposed to the XY plane. This XZ plane may be the XZ plane of the XYZ coordinate system established with respect to block 615 of method 600, or it may be another plane suited for the following analysis. In particular, the XZ plane may be perpendicular to a certain section of the offset wellbore. The reference wellbore point M_{R} should lie in the XZ plane. The uncertainty data for the reference wellbore point M_{R} may be projected onto the XZ plane, and may be combined with the uncertainty for the point where the offset wellbore section intersects the XZ plane. The XZ plane may be divided into sectors, as similarly done to the XY plane of method 600. The offset wellbore may not cut through all of these sectors in the XZ plane (or through all of the wedges along the Y axis created by these sectors). In each of the sectors in the XZ plane (or wedges along the Y axis), an appropriate radial distance from the point M_{R} may be determined. These radial distances may or may not correspond to distances from M_{R} to the offset wellbore. These radial distances (in the XZ plane sectors) may create a boundary that is an alternative to the boundary used in method 600. Further, the UC probability for the alternative boundary may be defined in the XZ plane, similar to the calculation of the UC probability for the boundary defined in the XY plane that is used in method 600.

In another implementation, an XYZ coordinate system with a different orientation than that used in method 600 may be selected. The origin of the XYZ system may be the reference wellbore point M_{R}. In particular, the XYZ system may be selected such that the Z axis coincides with the local (or predominant) direction of the reference wellbore at a certain depth. As such, the XY plane may become perpendicular to the local (or predominant) direction of the reference wellbore. The XY plane may therefore coincide with the plane used for the Travelling Cylinder Diagram (or Travelling Cylinder plot) known to those skilled in the art. The UC probabilities described above (including UC probabilities for crossing above versus below the offset wellbore section) may be defined and calculated in the new XYZ system or in the new XY system, similar to the calculations described in method 600.

### UC Probability Using DH Probability Methodologies

In yet another implementation, one or more UC probabilities may be determined using the methodologies described above with respect to determining DH probabilities. In particular, for instances where the “unwanted” region (i.e., a volume V_{UC}) that the reference wellbore is to avoid is tubular in shape, then the UC probability between a reference wellbore section and an offset wellbore section may be determined using implementations described above with respect to FIGS. 4 and 5.

In particular, the volume V_{UC} may be similar to the volumes described above with respect to FIGS. 6 and 8, in that the volume V_{UC} may include the offset wellbore section and some extended region proximate to the offset wellbore section. However, in contrast with these volumes discussed earlier, the volume V_{UC} in this implementation may be realized with a particular tubular shape, which would be similar to the shape of the volume V_{DH} discussed above. However, the volume V_{UC} in this implementation may extend outside the volume V_{DH}, discussed above, to represent an extended region around the offset wellbore section that the reference wellbore section should avoid.

As such, in one implementation, the probability that a reference wellbore point M_{R} is disposed within such a tubular volume V_{UC} may be determined using the methodologies discussed above for determining DH probabilities.

In particular, the UC probabilities for such an implementation may be assessed by dividing V_{UC} into a number of segments, evaluating the fundamental probability formula (see Equation 1) within each segment, and then summing the contributions from all of the segments.

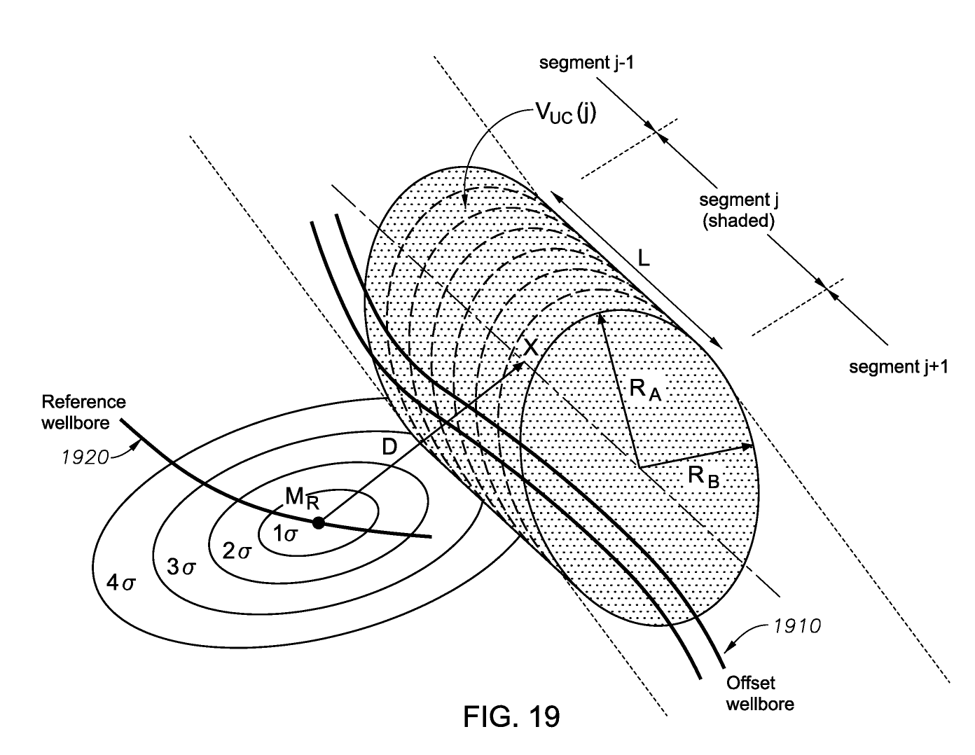

For example, FIG. 19 illustrates a schematic diagram of a multiple wellbore environment in accordance with implementations of various techniques described herein. In particular, as shown, a reference wellbore section 1920, with a reference wellbore point M_{R}, may be drilled in proximity to an offset wellbore section 1910, as represented by a volume with the combined radii of the two wellbores. Further, the combined uncertainty of the two wellbore sections is represented by the concentric ellipsoids of differing confidence regions assigned to the reference wellbore point M_{R}.

The “unwanted” region proximate to the offset wellbore section 1910 that the reference wellbore section 1920 is to avoid is represented by J number of segments (where J is an integer greater than one), though only one segment of the J segments is shown in FIG. 19. The segment j (where j is an integer from 1 to J) that is shown corresponds to a volume V_{UC}(j), where the volume V_{UC}(j) is shown as encompassing a portion of the offset wellbore section 1910.

As such, the segment j (i.e., volume V_{UC}(j)) corresponds to a portion of the “unwanted” region proximate to the offset wellbore section 1910 that the reference wellbore section 1920 is to avoid. As shown in FIG. 19, the segment j is tubular in shape, as are all of the remaining J segments, which are also similar to the segments of the volume V_{DH} discussed above with respect to FIGS. 4-5. The segments which neighbor segment j are reference by the text “segment j−1” and “segment j+1”.

As also shown in FIG. 19, the segment j may be established such that it is symmetrical about its center point X. The center point X may be positioned at a distance D from the reference wellbore point M_{R}, such that the offset wellbore section is disposed between the center point X and the reference wellbore point M_{R}.

As is further shown in FIG. 19, the cross-section of the segment j may be elliptical, and may be described by the ellipse's principal radii R_{A} and R_{B}. The segment j may also have a length L, which can be defined using Equation 2 described above, where R_{O} and R_{R} may be substituted with R_{A} and R_{B}. In one implementation, the radii R_{A} and R_{B} are not related to the radii of the offset or reference wellbores, and may be chosen at any value needed to define a desired “unwanted” region proximate to the offset wellbore section 1910. In addition, the radii R_{A} and R_{B} may not necessarily be equal to one another, and one or both of them may vary from one segment to another. In some implementations, the cross-section of segment j may be non-elliptical. Furthermore, in some implementations, the length L may be determined using cross-sectional dimensions (e.g., radii) of the segment.

In some implementations, the other segments of the J segments may be similarly defined with similar parameters as segment j, and these segments may also be symmetrical about their respective center points. The gap between consecutive segments may also be as small as possible, and the overlap between volumes of consecutive segments may be as small as possible. Further, the offset wellbore section may be disposed within the J segments, where a boundary created by the consecutive segments may lie between the offset wellbore section and the reference wellbore section.

While each of the J segments need not be of the same size and shape, having the cross-section of the segment (e.g., segment j) be elliptical may allow for the use of the P_{DH} equations and methodologies discussed above with respect to FIGS. 4-5 to determine the UC probabilities between the reference wellbore section and the J segments.

For example, given that the center point X of the segment j is positioned farther from the reference wellbore point M_{R} than the offset wellbore section, Equation 6 (and method 400) discussed with respect to FIG. 4 may be used to determine the UC probability that the reference wellbore point M_{R} has crossed into the volume V_{UC} within segment j.

In addition, as similarly discussed with respect to FIG. 4, after determining these UC probabilities between the reference wellbore point M_{R} and all of the J segments of the offset wellbore section, a total UC probability that the reference wellbore point M_{R} has crossed into the volume V_{UC} within the J segments can be determined by summing the UC probabilities.

Furthermore, by following method 500 and Equation 8 as discussed with respect to FIG. 5, a UC probability that the reference wellbore point M_{R} has crossed into the volume V_{UC} within segment j when drilling along an analysis interval of the reference wellbore section may be determined. After determining these UC probabilities with respect to each segment, a total UC probability that the reference wellbore point M_{R} has crossed into the volume V_{UC} within the J segments when drilling along the analysis intervals of the reference wellbore section may be determined by summing the UC probabilities.

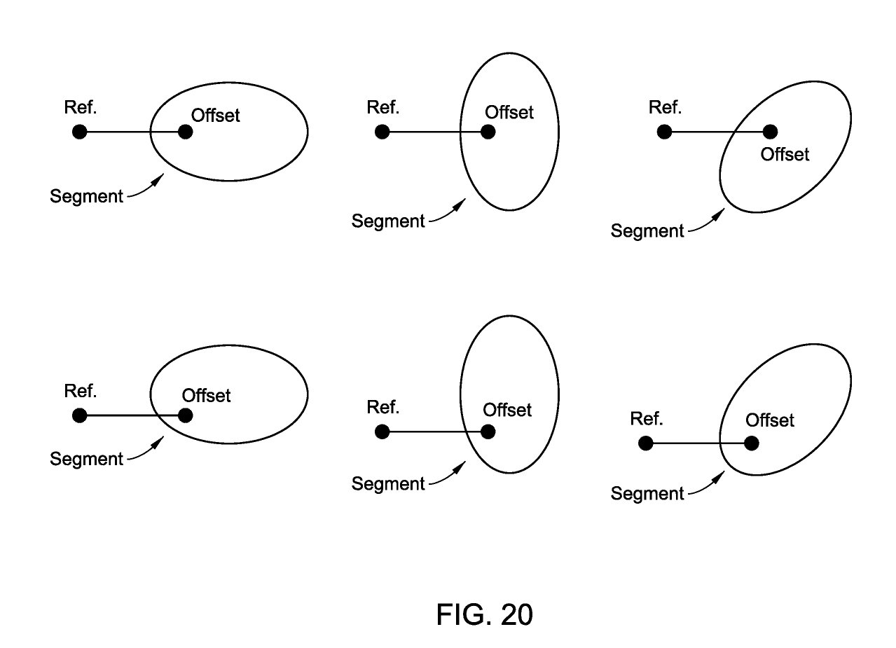

As mentioned above, each of the J segments need not be of the same size and shape. As such, there may be flexibility as to the size, orientation, and location of each segment with respect to the offset and reference wellbore sections, such that the collection of the J segments, when considered together, provides an adequate representation of the volume V_{UC} of the “unwanted” region that the reference wellbore section is to avoid. For example, FIG. 20 illustrates cross-sectional schematic diagrams of a multiple wellbore environment in accordance with implementations of various techniques described herein.

In particular, FIG. 20 shows multiple instances of a reference wellbore section drilled in proximity to an offset wellbore section, where the offset wellbore section is encompassed by a corresponding to a volume V_{UC}. For purposes of illustration, the reference (labeled as “Ref.”) and offset (labeled as Offset”) wellbore sections may be assumed to be perpendicular to the plane of FIG. 20, though each section may be curved in reality.

In addition, in each instance, the segment (labeled as “Segment”) may be established such that it is symmetrical about its center point (not shown in FIG. 20). In one implementation, each center point may be positioned such that the offset wellbore section is disposed between the center point and the reference wellbore section. In other implementations, the center point may be positioned otherwise with respect to the offset and reference wellbore sections, such that the segment provides an adequate representation of a part of the volume V_{UC} of the “unwanted” region that the reference wellbore section is to avoid. While the segment of each instance may have a cross-section that is elliptical, the instances may have different radii R_{A} and R_{B}. Accordingly, the differing sizes, orientation, and locations of the segment of each instance with respect to the offset and reference wellbore sections demonstrate that the segments used to determine the UC probabilities in these implementations can differ based on the wellbore trajectories, on geological concerns, on drilling, steering, or targeting processes, and/or the like.

The implementations described above may be used to determine one or more UC probabilities between a reference wellbore and an offset wellbore. In particular, these implementations may be used to determine one or more UC probabilities between an offset wellbore section and a reference wellbore point of a reference wellbore section, or to determine one or more UC probabilities between an offset wellbore section and a reference wellbore section. As mentioned above, a drilling operator may use these determined UC probabilities when making decisions on whether to follow or alter a drilling plan, as an unintentional crossing event may indicate a relatively low knowledge of the relative positions of the wellbores, and it could potentially lead to a direct hit if the reference wellbore is steered in an incorrectly-presumed safe direction. Additional details regarding the methods for determining the one or more UC probabilities between a reference wellbore and an offset wellbore are described below in the Further Discussion section.

### FURTHER DISCUSSION

As noted above, “well to well contact” may hereinafter be termed as a direct hit (DH), whereas the event of contacting or unknowingly crossing the offset wellbore may hereinafter be termed unintentional crossing (UC), where the inclusion of a possible direct hit is tacitly understood. The UC probability may be considered as seriously as the DH probability, because a UC event in many cases may indicate unacceptably low knowledge of the relative positions of the wellbores. Furthermore, an unintentional crossing may lead to a direct hit if the decision is made to steer the reference wellbore in a presumably safe direction.

For the same wellbore geometry and position uncertainty scenario, the DH probability may be much smaller than the UC probability. This may indicate that the DH and UC events may require different analysis procedures, and furthermore that the results cannot be compared directly. For both the DH and the UC analyses, it is the relative position uncertainty between the two wellbores that may be of importance. The relative uncertainty may also be denoted as the combined uncertainty. The combined uncertainty is calculated by combining the uncertainties of the two wellbores, such as the uncertainties at two specific points, one in each wellbore. Consider two points, M_{R} in the reference wellbore and M_{O} in the offset wellbore, with position uncertainties given by the 3D covariance matrices E_{MR} and E_{MO}, respectively. M_{R} and M_{O} may be assumed to be on the wellbores' respective center lines, and the distance between them is denoted D_{RO}. If the uncertainties of M_{R} and M_{O} are uncorrelated, the 3D uncertainty of D_{RO} is the combined uncertainties of M_{R} and M_{O}, given by:

Σ_{DRO}=Σ_{MR}+Σ_{MO} (9)

If Σ_{MR} and Σ_{MO} are partially correlated, Σ_{DRO} may become a more complex combination of the two.

Without loss of generality in the present context, it may be assumed that one of the points (e.g., M_{O}) is fixed, and all relative uncertainty may therefore be assigned to the other point (M_{R}). In one implementation, a step to facilitate the calculations may be to extend the radius of the offset wellbore so that it accounts for the dimensions of both wellbores, whereas the reference wellbore may be represented by its center line only. The extended radius may be the sum R_{R}+R_{O}, where R_{R} and R_{O} may be nominal radii of the reference and offset wellbores, respectively. FIG. 3 illustrates a model for analysis of relative position uncertainty between two points in accordance with implementations of various techniques described herein. In particular, FIG. 3 shows a model for analysis of relative position uncertainty between two points, M_{R} and M_{O}. The relative uncertainty, represented by the 1σ error ellipsoid (surface of 1σ confidence region), is centered at M_{R}, and the combined dimension of the two wellbores is assigned to the offset wellbore. Both wellbores may be 3D trajectories.

In one implementation, to account for the radii and a possible additional distance margin Sₘ that accounts for the uncertainty of the drilling and steering process, the distance between the two wellbores points may be expressed as

D=D_{RO}(R_{O}+R_{R})Sₘ (10)

The covariance matrix Σ_{D} for D will equal Σ_{DRO}.

With this model, both the direct hit and the unintentional crossing probabilities can be evaluated by the fundamental probability formula

P(M_{R} inside V)=∫∫∫_{V}ƒ(3D)dV (11)

where ƒ(3D) is the 3D probability density distribution function (PDF) corresponding to the relative uncertainty, and P is the probability that the true position of M_{R} lies inside the volume V. V may be referred to as the “unwanted region”, defined as the part of space that represents a DH or a UC event. The coordinate system may be chosen so as to best accommodate the evaluation of Equation 11. However, the practical aspects of calculating Equation 11 may depend heavily on the shape of the volume V.

FIGS. 7 and 8 illustrate examples of unwanted regions for a direct hit (DH) event and an unintentional crossing (UC) event. The probabilities of the hitting or crossing events may be found by integrating the PDF (shown as co-centric ellipsoids) over the regions V_{DH} (representing the offset wellbore with combined radii) or V_{UC}, respectively. The shape of the V_{UC} region has been arbitrarily chosen for illustration purposes only. In both figures, both wellbores may be 3D trajectories.

For the DH probability P_{DH}, V may be the volume V_{DH} of the offset wellbore with extended radius, or a similar volume that represents the integrity zone of the offset wellbore (for example, with respect to pressure isolation) that the reference wellbore should not enter. Such a volume is shown in FIG. 7, as discussed above, where FIG. 7 illustrates a schematic diagram of a multiple wellbore environment in accordance with implementations of various techniques described herein. The scenario can be analyzed by analytic methods for favorable geometries, like straight wellbore sections and high symmetry of the uncertainty ellipsoid with respect to the wellbores' directions. For arbitrary wellbore geometries and arbitrary orientations of the ellipsoid, Monte Carlo (MC) simulation may be used to assess the direct hit probability accurately. Some disadvantages of the MC approach may include that the technique provides relatively poor physical insights, and that sensitivity analysis and analysis of low-probability events may require long computation times.

For the UC probability P_{UC}, there may be no standard procedure for choosing the volume V_{UC} and its boundary. One example is shown in FIG. 8. FIG. 8 illustrates a schematic diagram of a multiple wellbore environment in accordance with implementations of various techniques described herein. The definition of V_{UC} may be guided by two principles: V_{UC} should closely represent the spatial region that one wants to avoid; and it must be possible to evaluate, or at least approximate, the integral in Equation 11 over this volume.

One approach to determine P_{UC} may be to compare the distance D (equation 10) with the 1D uncertainty (standard deviation σ_{D}) in the D-direction. This may be done in terms of the critical distance

D_{crit}=kσ_{D} (12)

where the scaling parameter k determines the confidence level of the analysis. k may be user-defined and set to a value that implies the accepted probability of an unintentional crossing when the surveyed separation distance Dₛᵤᵣᵥ (given by e.g., Equation 10) equals the critical distance. The comparison of Dₛᵤᵣᵥ to D_{crit} may be expressed by a separation factor (SF). The SF may be determined using a number of approaches, as known in the art. The form presented herein relates to the probability, hence the subscript “P”:

SF_{P}=Dₛᵤᵣᵥ/D_{crit}=Dₛᵤᵣᵥ/kσ_{D} (13)

One criterion for continued drilling is that Dₛᵤᵣᵥ yields an SF that fulfils

SF≥1 (14).

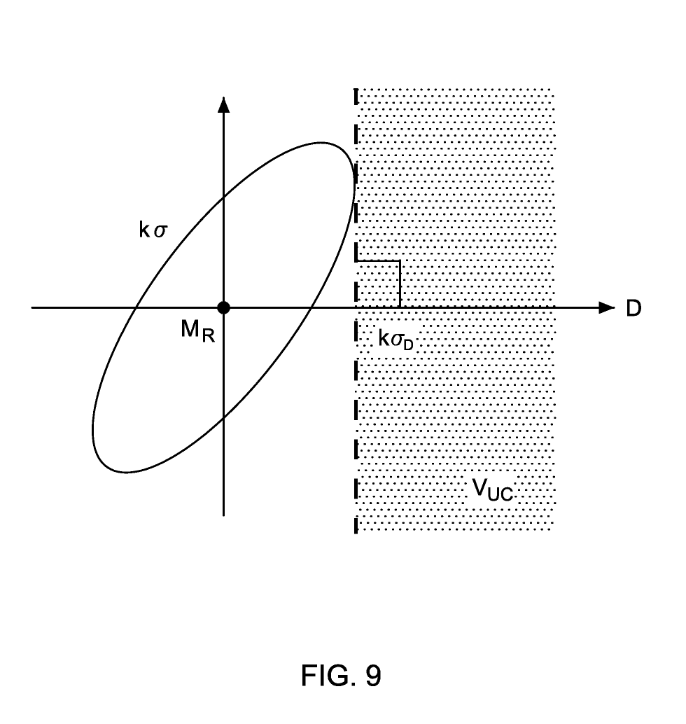

The standard deviation σ_{D} can be found mathematically from Σ_{D}, or graphically as the projection of the 1σ ellipse or ellipsoid onto the direction of D, as illustrated in FIG. 9. σ_{D} may be a point on a pedal curve (or pedal surface), which may be determined by projecting the 1σ ellipse (or ellipsoid) onto varying directions in a 2D plane or in 3D space. FIG. 9 illustrates a graphical diagram of an uncertainty ellipsoid for a multiple wellbore environment in accordance with implementations of various techniques described herein. In particular, FIG. 9 illustrates the projection procedure (i.e., pedal curve method) that yields direction-dependent uncertainties. The kσ ellipsoid/ellipse may project onto the D direction at point kσ_{D}.

One advantage of the above approach may be that it implicitly defines a convenient V_{UC}. This is also shown in FIG. 9. The boundary of V_{UC} becomes a line perpendicular to the D-direction in 2D, or a plane perpendicular to the D-direction in 3D. The boundary line or plane is located at distance kσ_{D} from M_{R}. The boundary of V_{UC} is shown by the dashed line in FIG. 9, and V_{UC} is shown by the cross-hatched region. The example illustrated in FIG. 9 is shown in 2D; however, it can be extended to 3D.

Applying the pedal curve method, Equation 11 can be reduced to

P(M_{R} inside V)=P(M_{R} beyond kσ_{D})=∫_{kσ}_{_{D}}^{∞}ƒ(1D)dD (15),

where ƒ(1D) is the 1D PDF (along D) that results from integrating ƒ(3D) over the two dimensions perpendicular to D. However, this integration step may not be necessary, because the same distribution shape may apply for ƒ(1D) as for ƒ(3D). Furthermore, if ƒ(1D) is a normal distribution, the evaluation of the integral in Equation 15 becomes well known to those skilled in the art.

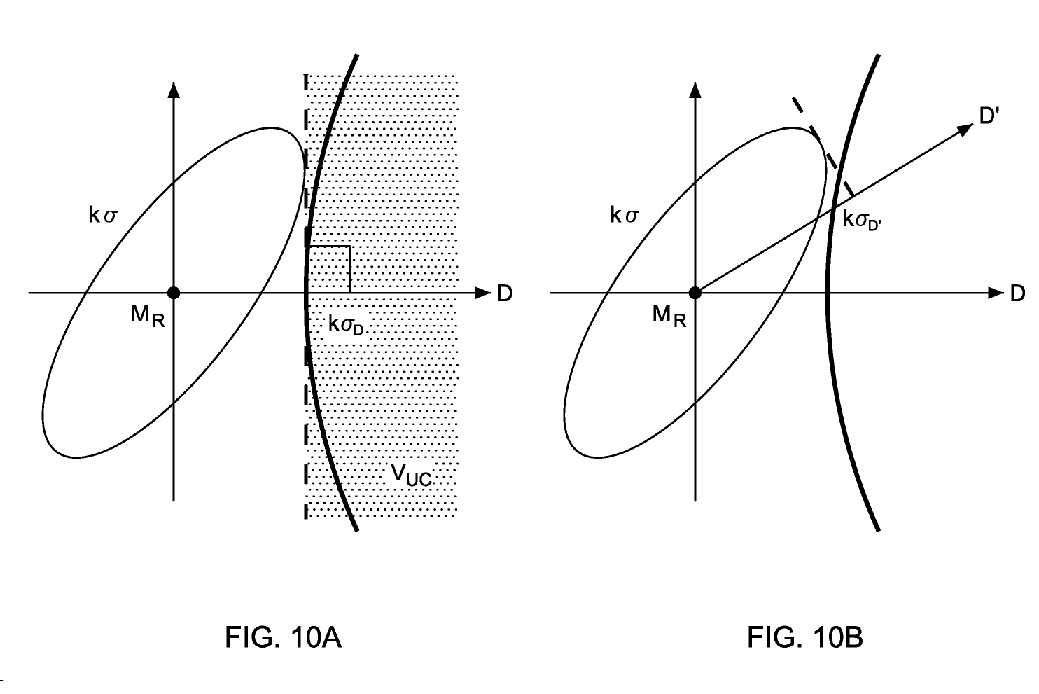

As thus far explained in this section, the points M_{R} and M_{O} may have been selected without considering the directions of the two wellbores, or the elongation or orientation of the ellipsoids that represent the combined uncertainty. However, if the geometries of the wellbores or of the ellipsoids are not particularly simple, the planar boundary may not give an adequate representation of the unwanted region. For example, FIGS. 10A-10B illustrate graphical diagrams of a multiple wellbore environment in accordance with implementations of various techniques described herein. For clarity, wellbore cross-section dimensions have been neglected and the examples illustrated in FIGS. 10A-10B are shown in 2D; however, they can be extended to 3D. In particular, the situation in FIG. 10A may appear to be conservative, because the offset wellbore (shown by the thick solid line) may lie entirely within the unwanted region (shown by the cross-hatched region) for which P_{UC}, by assumption, may be acceptable. However, when considering an alternative direction D′ (FIG. 10B), the offset wellbore may actually lie closer to M_{R} than does kσ_{D′}; hence, the SF criterion (Equation 12) may be violated.

One reason that one may arrive at the wrong conclusion for cases such as FIG. 10A is that only one direction has been considered. This may be characteristic for the closest approach method and the perpendicular scan method, which are known to those skilled in the art. Both of these methods may identify the two points M_{R} and M_{O} as those wellbore points that are geometrically closest to each other. In FIG. 10A, the point at which the offset wellbore intersects the D axis may fulfill such criteria, for example if the reference wellbore curves in the opposite direction of the offset wellbore. Alternatively, one of the points M_{R} and M_{O} may first be determined based on certain external criteria, and the other point is identified as the point in the other wellbore that is geometrically closest to the first point. Wellbore uncertainties may be ignored when determining the two points by the closest approach or perpendicular scan or similar procedures, and only the resulting point pair may be considered in the subsequent analysis. For general cases with curved wellbores and elliptic PDFs that are non-symmetric with respect to the wellbore directions, as exemplified by FIGS. 10A-10B, ignoring the uncertainties when identifying the two points M_{R} and M_{O} may lead to misleading probability results and overly optimistic conclusions, because other point pairs with higher collision probabilities might have been neglected in the analysis.

The implementations disclosed herein present analytic methods for both the DH and the UC probability scenarios that do not rely on the closest approach or perpendicular scan procedures, but consider the hitting and/or crossing probability between M_{R} and a series of points in the offset wellbore. These methods may therefore be capable of identifying the points for which the DH or UC probability is highest. Moreover, the implementations disclosed herein may give improved probability estimates for general wellbore geometries and uncertainty-ellipsoid orientations, compared with other methods that may be based on the closest approach or perpendicular scan procedures.

With respect to the implementations described herein, a number of assumptions may be made. Such assumptions may include:
The reference and offset wellbore trajectories are realistic, in the sense that the wells are actually possible to drill. Otherwise, there are no restrictions on the geometries of either wellbore, nor are there restrictions on their placement or orientation with respect to each other.
Directional data (measured depth MD, inclination I, and azimuth A) may be available at survey intervals (e.g., 10-30 meters (m)) throughout the reference and offset wellbore sections of interest, either from real surveys or from well plans. These data have been quality checked by standard QC procedures, and there are no gross errors present. The directional data are converted into nominal north (n), east (e), and vertical (v) coordinates at the same MD locations by standard techniques. Both wellbores' trajectories are centered on the nominal (n, e, v) positions.
The analysis points M_{R} and M_{O} can be chosen anywhere along the reference and offset wellbore sections, i.e., not necessarily at a survey station (see below about data interpolation).
Unless near the physical end of the offset wellbore, in which case the analysis should consider the true geometry, the offset wellbore section of interest may be chosen so long that the probability that M_{R} hits or crosses any of its ends is virtually zero. This may be verified, such as by evaluating the relative uncertainty at offset wellbore points where the probability is assumed to be negligible.
The wellbores may be described as having circular cross sections, with radii R_{R} and R_{O}, respectively. These radii may represent the zones that should not interfere, i.e., typically the open-hole dimensions. To simplify the description of the algorithms, R_{R} and R_{O} may be assumed to be constant along the wellbore sections of interest. However, this does not restrain the methods to only such cases where R_{R} and R_{O} are constant, and along-hole changes to either radius can be incorporated.
Position uncertainty estimates may be available at the same locations as the (n, e, v) data in both wells, and may be represented by 3D covariance matrices given in the north-east-vertical (NEV) coordinate system. The position uncertainties may include survey uncertainties from real or planned surveys evaluated by adequate and qualified error models, surface position uncertainties, and other possible position uncertainties representing issues such as the ability to drill or steer, as far as these are available. Possible biases may be removed or treated using methods known to those skilled in the art.
Directional data (I and A) and position data (n, e, v) can be interpolated to any desired MD in both the reference and the offset wellbore sections. Similarly, the covariance matrices can be interpolated to any desired MD. Because the uncertainties change relatively slowly with MD, a linear interpolation method (which inevitably produces a valid covariance matrix) may be used for survey intervals of 10-30 m. However, other interpolation methods known to those skilled in the art may also be used to interpolate the covariance matrices to the desired MD.
The relative position errors can be determined similar to Equation 9 between any pair of (interpolated) points M_{R} and M_{O}, with proper handling of known well-to-well correlations. The relative position errors may be assigned to M_{R}. Furthermore, the wellbore dimensions may be combined (as described below for each method) and assigned to the offset wellbore. The model is as shown in FIG. 3.

For both DH and UC analysis, the integral in Equation 11 may be assessed by dividing the volume V into a total of J cells, evaluating the integral within each cell, and then summing the contributions from all cells:

P=Σⱼ₌₁^{J}=P(j) (16)

where P(j) is the contribution to the total probability obtained from cell j, over the volume Vⱼ:

P(j)=∫∫∫_{V}_{ⱼ}ƒⱼ(3D)dV (17)

The notation fⱼ in Equation 17 indicates that the combined uncertainty may vary from one cell j to another. This may be due to the offset wellbore uncertainty changing along the offset wellbore.

The division into cells should be done such that the volumes Vⱼ of individual cells j do not overlap, but add up to the total volume V (V_{DH} or V_{UC}):

V=Σⱼ₌₁^{J}Vⱼ (18)

The cell for which the DH and/or UC probability is highest can be determined from the set of P(j). Although this point in the offset wellbore may not be needed for further analysis, it may be of interest to display its location.

The technique of evaluating the probability in small volume cells numerically, for example as a centroid PDF value multiplied by the volume of the cell, is known to those skilled in the art. However, the accuracy of the results will depend on the shape and volume of each cell. This is an important issue for UC calculations, where the total volume of the unwanted region may be very large, implying an impractical number of cells. Furthermore, for DH calculations, the combined cross-section dimensions of the wellbore, which may be the natural dimensions for DH analysis cells, may also be so large that just a centroid PDF value multiplied by the volume of the cell may yield insufficient accuracy.

Considering the cells, the uncertainty distribution, and the calculation algorithms as a whole, and exploiting the relation between these elements, it may be possible to define algorithms that are feasible with respect to complexity and computation time, and still exhibit sufficient accuracy. Such algorithms are described with respect to the implementations disclosed herein for both the DH and the UC probability calculations.

In some implementations, guidelines can be used for the selection of the offset wellbore section to be included in the analysis, and for the cell sizes used for the subdivision of the volume. Such guidelines may be determined from the contributions P(j) from each cell to the total probability P. For example, the section length and the cell sizes may be chosen such that P(j) of any cell at or beyond the ends of the section does not exceed for example 1/10000 of the total P. Furthermore, the cell sizes may be chosen such that P(j) of any cell does not exceed for example 1/100 of the total probability P.

The guidelines, in terms of the criteria and the probability ratios suggested herein, may be verified and possibly revised based on testing of the methods on various scenarios. A priori estimates of the probability ratios, which may be calculated between M_{R} and a few original (i.e., not interpolated) survey locations in the offset wellbore, may help to specify the necessary section length and the cell sizes. Furthermore, upon completion of a probability analysis, the probability ratios may be evaluated as part of the quality control. However, conformity with criteria such as those discussed here may not be sufficient on its own to make claims about the overall accuracy of the results.

In the following sections where the DH and the UC methods are described separately, the term “segment” will be used for a cell in the DH method, and the term “wedge” will be used for a cell in the UC method.

### Direct Hit (DH) Probability—Points Versus Segment and Point Versus Section Scenarios

The contents of this section is an extended and more detailed description of the procedure that has earlier been described with respect to FIG. 4.

The offset wellbore section (with the combined radii assigned to it) is divided into J cylindrical segments of constant length L, measured as increments in measured depth (ΔMD) along the wellbore's centre line. In some implementations, L may be chosen to be different for different segments, and, in particular, L may be a function of the radii of the two wellbores. L should be comparable to the combined wellbore radius; however, it will be specified later. The wellbore curvature over one segment is neglected, and it is assumed that the cylinder ends are parallel planes; however, these planes need not necessarily be perpendicular to the L axis of the segment. Possible gaps or overlaps between consecutive segments that are caused by the wellbore curvature, are neglected, because they will be very small compared to each segment's volume, and tend to cancel out between the concave and the convex sides of the curve. The segments are therefore assumed to sum up to the total volume of the offset wellbore section.

Each of the J segments will be referred to by the index j(j=1 . . . J). For each segment j, the center point is assumed to lie on the center line of the offset wellbore. Furthermore, the center point of each segment j, which may be referred to as center point j, corresponds to the offset wellbore point M_{O} in the earlier description.

Consider one segment j and the analysis point M_{R} in the reference wellbore. The cross section of the segment will be an ellipse, as shown in FIGS. 11A-11B. The ellipse's longer principal axis R₁ will be

R₁=R_{O}+R_{R} (21)

whereas the shorter principal axis R₂ is

R_{2,MR,j}=R_{O}+R_{R}|cos(β_{MR,j})| (22)

where β_{MR,j} is the local angle between the wellbores, and cos(β_{MR,j}) is given by the inner product of the local tangent vectors. The shape and volume of segment j therefore depends on both points M_{R} and j:

V_{MR}(j)=πR₁R_{2,MR,j}L (23)

FIGS. 11A-11B illustrate schematic diagrams of a multiple wellbore environment in accordance with implementations of various techniques described herein. In an actual drilling situation, a reference wellbore approaching from the left as in FIGS. 11A-11B cannot intersect with the right-hand part of the segment (dashed lines in FIG. 11B) without first having passed through the left-hand part. In fact, the collision physically occurs at the moment when the outer surfaces (of holes or casings) touch, corresponding to the left-hand half of the segment's surface. However, integrating the PDF over this surface alone would give a collision probability of zero. This unphysical situation is solved by observing that drilling is a dynamic process that moves point M_{R} relative to the offset wellbore; hence, the collision probability can only be stated as a probability per drilled interval. This question will be approached later, after the “static” collision probability between the single point M_{R} and segment j has been determined. The “static” collision probability, which results when integrating the PDF over the total volume shown in FIGS. 11A-11B, complies with the industry's current practice for describing the collision between two planned wells, or between a planned well and an existing well.

FIG. 11A illustrates, at the top, two wellbores (R=reference; O=offset) with an angle β_{MR,j} between their local tangential directions. Below, it illustrates the projections of the wellbore cross sections, when viewed along the offset wellbore. Two positions of the reference wellbore relative to the offset well are indicated. FIG. 11B shows that when the reference wellbore is moved around the offset wellbore, the minimum separation distance (i.e., when the wellbores just touch) traces out the solid curve, which is an ellipse. The principal axes of this ellipse are given by Equations 21 and 22.

The symmetry of the segment is essential for the further derivation. This symmetry can be expressed as:

if (a,b,c)ϵV_{MR}(j), then (−a,−b,−c)ϵV_{MR}(j) (24)

for any point (a, b, c) in an arbitrarily oriented coordinate system ABC with origin at the segment's center.

In some implementations, the segments may be defined with shapes or cross-sections other than the cylindrical shape and elliptical cross-section described above. In particular, such segments may be used to avoid using the whole segment volume illustrated in FIG. 11B (left-hand half plus right-hand half) in the calculations when the reference wellbore approaches from one side, as discussed above. Alternative segment shapes may therefore include, for example, cuboid shapes, with dimensions chosen to approximate only part of the volume shown in FIG. 11B (e.g., only the left-hand half of the volume). The center point of each segment may be defined with respect to the segment as before. However, the segment may be displaced with respect to the wellbore such that the segment's center point no longer lies on the wellbore's center line. As long as the new segments exhibit the symmetry as described by Equation 24, the methodology discussed below can be adapted for such alternative segment shapes.

As described above, position data and covariance matrices are by assumption available at M_{R} and center point j, if necessary by interpolation along MD, and the relative uncertainty between the two points is found by combining the covariance matrices at the two points. The eigenvectors of the combined covariance matrix constitute the principal axes XYZ of the corresponding uncertainty ellipsoid. The XYZ system is centered at M_{R}. When expressed in the XYZ system, the 3D PDF separates into the product of three independent 1D functions ƒ_{X}, ƒ_{Y}, and ƒ_{Z}:

ƒ_{XYZ}(x,y,z;σ_{X},σ_{Y},σ_{Z})=ƒ_{X}(x;σ_{X})ƒ_{Y}(y;σ_{Y})ƒ_{Z}(z;σ_{Z}) (25)

Indices M_{R} and j have been omitted to simplify the notation. The standard deviations σ_{X}, σ_{Y}, and σ_{Z} are the square roots of the respective eigenvalues.

Each of ƒ_{X}, ƒ_{Y}, and ƒ_{Z} is normalized such that each of the 1D integrals over [−∞, ∞] amounts to unity. However, the processing method that leads to the DH probability may not require any particular probability density distribution function. The only requirement is that each 1D PDF must have a well-defined Taylor expansion series, which is known (analytically or numerically) to 2^{nd} order. Furthermore, to represent realistic position uncertainties, the PDF should be bell-shaped and symmetric, and centered at M_{R}.

The integral in Equation 11 may not separate into the product of three independent 1D functions, as in Equation 25, because the surface boundaries of the volume V in general will be described by functions that relate the three variables to each other.

The distance vector D_{MR,j} from M_{R} to center point j,

$${D}_{MR , j} = [ \begin{matrix}{n}_{j} \\ {e}_{j} \\ {v}_{j}\end{matrix} ] - [ \begin{matrix}{n}_{MR} \\ {e}_{MR} \\ {v}_{MR}\end{matrix} ] \qquad ( 26 )$$

can be projected onto each of the principal axes X, Y, and Z, represented by the unit vectors u_{X}, u_{Y}, and u_{Z}, in NEV coordinates. This gives the coordinates (xⱼ yⱼ zⱼ) of center point j in the XYZ system:

xⱼ=uₓ^{T}D_{MR,j} yⱼ=u_{y}^{T}D_{MR,j} zⱼ=u_{z}^{T}D_{MR,j} (27)

The 3D PDF is expanded into a Taylor series around (xⱼ yⱼ zⱼ):

$${f}_{XYZ} ( x , y , z ) = \frac{1}{0 ! 0 ! 0 !} {f}_{X} ( {x}_{j} ) {f}_{Y} ( {y}_{j} ) {f}_{Z} ( {z}_{j} ) + \frac{1}{1 ! 0 ! 0 !} [ {f}_{X}^{′} ( {x}_{j} ) {f}_{Y} ( {y}_{j} ) {f}_{Z} ( {z}_{j} ) Δ x + {f}_{X} ( {x}_{j} ) {f}_{Y}^{′} ( {y}_{j} ) {f}_{Z} ( {z}_{j} ) Δ y + … ] + \frac{1}{2 ! 0 ! 0 !} [ {f}_{X}^{″} ( {x}_{j} ) {f}_{Y} ( {y}_{j} ) {f}_{Z} ( {z}_{j} ) Δ {x}^{2} + {f}_{X} ( {x}_{j} ) {f}_{Y}^{″} ( {y}_{j} ) {f}_{Z} ( {z}_{j} ) Δ {y}^{2} + … ] + \frac{1}{1 ! 1 ! 0 !} [ 2 {f}_{X}^{′} ( {x}_{j} ) {f}_{Y}^{′} ( {y}_{j} ) {f}_{Z} ( {z}_{j} ) Δ x Δ y + 2 {f}_{X}^{′} ( {x}_{j} ) {f}_{Y} ( {y}_{j} ) {f}_{Z}^{′} ( {z}_{j} ) Δ x Δ z + … ] + \frac{1}{3 ! 0 ! 0 !} [ {f}_{X}^{′′′} ( {x}_{j} ) {f}_{Y} ( {y}_{j} ) {f}_{Z} ( {z}_{j} ) Δ {x}^{3} + {f}_{X} ( {x}_{j} ) {f}_{Y}^{′′′} ( {y}_{j} ) {f}_{Z} ( {z}_{j} ) Δ {y}^{3} + … ] + \frac{1}{2 ! 1 ! 0 !} [ 3 {f}_{X}^{″} ( {x}_{j} ) {f}_{Y}^{′} ( {y}_{j} ) {f}_{Z} ( {z}_{j} ) Δ {x}^{2} Δ y + 3 {f}_{X}^{″} ( {x}_{j} ) {f}_{Y} ( {y}_{j} ) {f}_{Z}^{′} ( {z}_{j} ) Δ {x }^{2} Δ z + … ] + \frac{1}{1 ! 1 ! 1 !} [ 6 {f}_{X}^{′} ( {x}_{j} ) {f}_{Y}^{′} ( {y}_{j} ) {f}_{Z}^{′} ( {z}_{j} ) Δ x Δ y Δ z ] + O ( 4 ) \qquad ( 28 )$$

where Δx=x−xⱼ, Δy=y−yⱼ, and Δz=z−zⱼ, and O(4) indicates Taylor series terms of 4^{th} order or higher. The standard deviations σ_{X}, σ_{Y}, and σ_{Z} have been omitted from the notation for simplicity. All partial derivatives ƒ_{X}′, ƒ_{X}″, etc. are taken with respect to the variable indicated by the index, because for example ∂ƒ_{X}/∂y and ∂ƒ_{X}/∂z are both zero. Hence, the notation means ƒ_{X}′=∂ƒ_{X}/∂x, ƒ_{X}″=∂²ƒ_{X}/∂x², etc., where the right-hand expressions are standard notations for the partial derivatives. The functions ƒ_{X}, ƒ_{Y}, and ƒ_{Z} and their partial derivatives should all be evaluated at center point j (xⱼ yⱼ zⱼ), and are therefore constants with respect to the integral in Equation 11. Together with the numbers

$$\frac{1}{0 ! 0 ! 0 !} , \frac{1}{1 ! 0 ! 0 !} ,$$

etc., where “!” is the factorial operator, these constants form the Taylor coefficients, which all go outside the integrals, leading to:

P_{DH,MR}(j)=∫∫∫_{V}_{_{MR}}₍ⱼ₎ƒ_{XYZ}(x,y,z)dV=P₀+P₁+P₂+P₃+ . . . (29)

where

P₀=ƒ_{X}(xⱼ)ƒ_{Y}(yⱼ)ƒ_{Z}(zⱼ)∫∫∫_{V}_{ⱼ}dV (30)

P₁=[ƒ_{X}′(xⱼ)ƒ_{Y}(yⱼ)ƒ_{Z}(zⱼ)∫∫∫_{V}_{ⱼ}Δx dΔx dΔydΔz+ . . . ] (31)

P₂=(½)ƒ_{X}″(xⱼ)ƒ_{Y}(yⱼ)ƒ_{Z}(zⱼ)∫∫∫_{V}_{ⱼ}Δx² dΔxdΔydΔz+ . . . +2ƒ_{X}′(xⱼ)ƒ_{Y}′(yⱼ)ƒ_{Z}(zⱼ)∫∫∫_{V}_{ⱼ}ΔxΔy dΔxdΔydΔz+ . . . ] (32)

P₃=[(⅙)ƒ_{X}′″(xⱼ)ƒ_{Y}(yⱼ)ƒ_{Z}(zⱼ)∫∫∫_{V}_{ⱼ}Δx³ dΔxdΔydΔz+ . . . +( 3/2)ƒ_{X}″(xⱼ)ƒ_{Y}′(yⱼ)ƒ_{Z}(zⱼ)∫∫∫_{V}_{ⱼ}Δx²Δy dΔxdΔydΔz+ . . . +6ƒ_{X}′(xⱼ)ƒ_{Y}′(yⱼ)ƒ_{Z}′(zⱼ)∫∫∫_{V}_{ⱼ}ΔxΔyΔz dΔxdΔydΔz] (33)

The 0^{th} order term P₀ is the PDF value at the segment's center point (xⱼ yⱼ zⱼ), multiplied by the segment's volume. In many cases, this will be an adequate approximation to the true value of the integral. However, the higher order terms, which may be considered as corrections to P₀, change signs depending on where the segment is located in 3D space, making it computationally very challenging to determine whether P₀ is an optimistic or a conservative estimate. It is therefore highly desirable to include also higher order terms, if possible.

Each integral can be considered as the limit of the sum of a function g(Δx, Δy, Δz)dΔxdΔydΔz, when the dimensions dΔx, dΔy, and dΔz go to zero. Because of the symmetry stated in equation 24, both g(Δx, Δy, Δz) and g(−Δx, Δy, Δz) will be terms in the sum. Grouping these terms together as a pair, the pair will cancel out to zero when the g function is anti-symmetric. This is the case for all 1^{st} order terms, containing just one of Δx, Δy, or Δz, and furthermore for 3^{rd} order terms (which contain terms on the form Δx³, Δx²Δy, ΔxΔyΔz etc.) and, in fact, for all odd-order terms. Hence, P₁=P₃=0 in Equation 29.

The 2^{nd} order terms that constitute P₂ are of two types: the quadratic terms Δx², Δy², and Δz², and the cross-product terms ΔxΔy, ΔxΔz, and ΔyΔz. All of these are symmetric functions, so they cannot be eliminated through the argumentation used for odd-order terms. Furthermore, the cross-product terms cannot in general be split into separate integrals because the boundaries of one variable are functions of the other two variables. This further implies that the values of the 2^{nd} order integrals will depend on the segment's orientation with respect to the XYZ axes.

Evaluating the 2^{nd} order terms correctly (numerically or analytically) for any arbitrary orientation of the segment would be very cumbersome, and would most likely result in a very impractical algorithm. We shall instead approximate the terms by constant values, i.e., values that do not depend on the segment's orientation. To do this, it is assumed for the evaluation of the 2^{nd} order terms that the segment has circular cross section independent of the local angle between the wellbores. This implies replacing Equation 22 with R₂=R₁=R_{O}+R_{R}. This is close to the original Equation 22 when the wellbores are nearly parallel, but will over-estimate the segment's volume when they cross at higher angles. However, whether the over-estimation of the volume has a conservative or optimistic effect on P_{MR}(j) will depend on the signs of the second derivative terms at (xⱼ, yⱼ, zⱼ). It is therefore difficult to estimate the effect of the modification of R₂ on the total DH probability over the entire offset wellbore section, other than it becomes negligible when the wells are nearly parallel, and at higher angles, the result is expected to still be more correct than what is achieved by neglecting 2^{nd} order terms entirely.

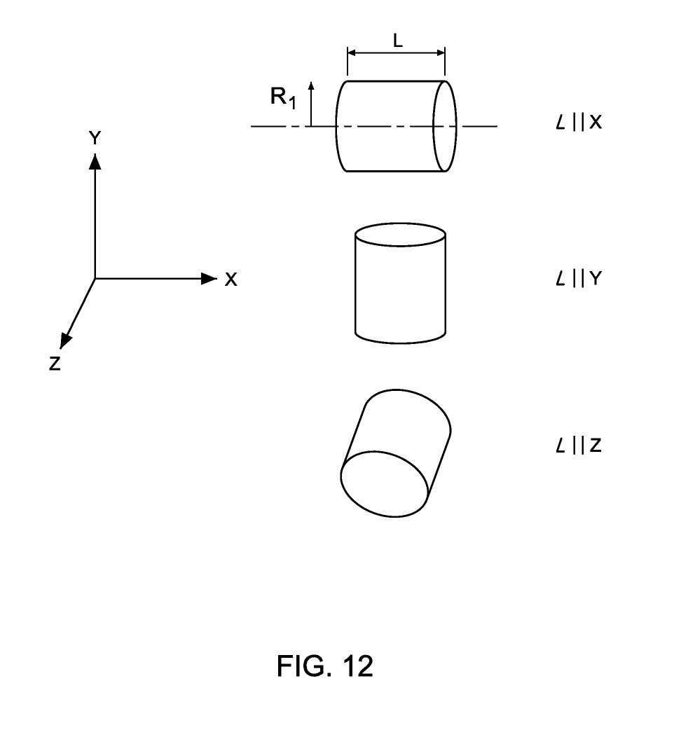

The constant (i.e., not orientation-dependent) results for the integrals of the 2^{nd} order terms are found by considering three principal orientations of the modified segment: i.e., with the L direction parallel to the X axis, to the Y axis, or to the Z axis, as shown in FIG. 12. FIG. 12 illustrates three principal orientations of the cylindrical segment in the XYZ coordinate system: with the L direction parallel to the X, to the Y, or to the Z axis. For evaluation of the 2^{nd} order Taylor terms, the segment is assumed to have a circular cross section with radius R₁, as given by Equation 21.

For the cross-product terms such as ΔxΔy, each of the three principal orientations effectively separates the 3D integral into individual 1D integrals, of which at least one will always evaluate to zero. This is shown for the integral over dΔx:

$$\begin{matrix}{P}_{2 , Δ x Δ y} ( Δ x ; L \vert \vert X ) = {{\int }_{- L / 2}}^{L / 2} Δ x d Δ x = 0 & ( 34 ) \\ {P}_{2 , Δ x Δ y} ( Δ x ; L \vert \vert Y ) = {{\int }_{- \sqrt{{R}_{1}^{2} - Δ {z}^{2}}}}^{\sqrt{{R}_{1}^{2} - Δ {z}^{2}}} Δ x d Δ x = 0 & ( 35 ) \\ {P}_{2 , Δ x Δ y} ( Δ x ; L \vert \vert Z ) = 0 & ( 36 )\end{matrix}$$

Equation 36 is the same as Equation 35, by interchanging Δy and Δz.

By changing the variables, the same results (Equations 34 through 36) are obtained for the dΔy and the dΔz integrals. This means that all integrals over ΔxΔy, ΔxΔz, and ΔyΔz vanish for the three principal orientations of the segment. It is therefore reasonable to choose the average of these three results as valid for any orientation; hence, the contributions from the cross-product terms are always zero.

For the quadratic terms such as Δx², the integrals do not vanish. Their values are:

$$\begin{matrix}{P}_{2 , Δ {x}^{2}} ( Δ x ; L ∥ X ) = \frac{1}{2} {f}_{X}^{″} {f}_{Y} {f}_{Z} \int {\int }_{circle ( {R}_{1} )} d Δ yd Δ z {\int }_{- L / 2}^{L / 2} Δ {x}^{2} d Δ x = {f}_{X}^{″} {f}_{Y} {f}_{Z} \frac{π}{24} {R}_{1}^{2} {L}^{3} & ( 37 ) \\ {P}_{2 , Δ {x}^{2}} ( Δ x ; L ∥ Y ) = \frac{1}{2} {f}_{X}^{″} {f}_{Y} {f}_{Z} {\int }_{- L / 2}^{L / 2} d Δ y {\int }_{- {R}_{1}}^{{R}_{1}} d Δ z {\int }_{- \sqrt{{R}_{1}^{2} - Δ {z}^{2}}}^{\sqrt{{R}_{1}^{2} - Δ {z}^{2}}} Δ {x}^{2} d Δ x = {f}_{X}^{″} {f}_{Y} {f}_{Z} \frac{π}{8} {R}_{1}^{4} L & ( 38 ) \\ {P}_{2 , Δ {x}^{2}} ( Δ x ; L ∥ Z ) = {f}_{X}^{″} {f}_{Y} {f}_{Z} \frac{π}{8} {R}_{1}^{4} L & ( 39 )\end{matrix}$$

Equation 39 is the same equation 38, by interchanging Δy and Δz.

Up to this point, the segment length L has not been specified. The segment L can be selected to make the integrals virtually independent of the segment's orientation. By choosing L as:

L=\sqrt{3}R₁=\sqrt{3}(R_{O}+R_{R}) (40)

which also agrees well with the initial assumptions for L, the three results in Equations 37-39 become equal to:

$${P}_{2 , Δ {x}^{2}} ( Δ x ) = {f}_{X}^{″} {f}_{Y} {f}_{Z} \frac{\sqrt{3} π}{8} {R}_{1}^{5} \qquad ( 41 )$$

This result is therefore considered to be a good approximation and therefore overall valid for any orientation of the segment.

By changing the variables, the Δy² and Δz² terms in equation 32 will produce corresponding results.

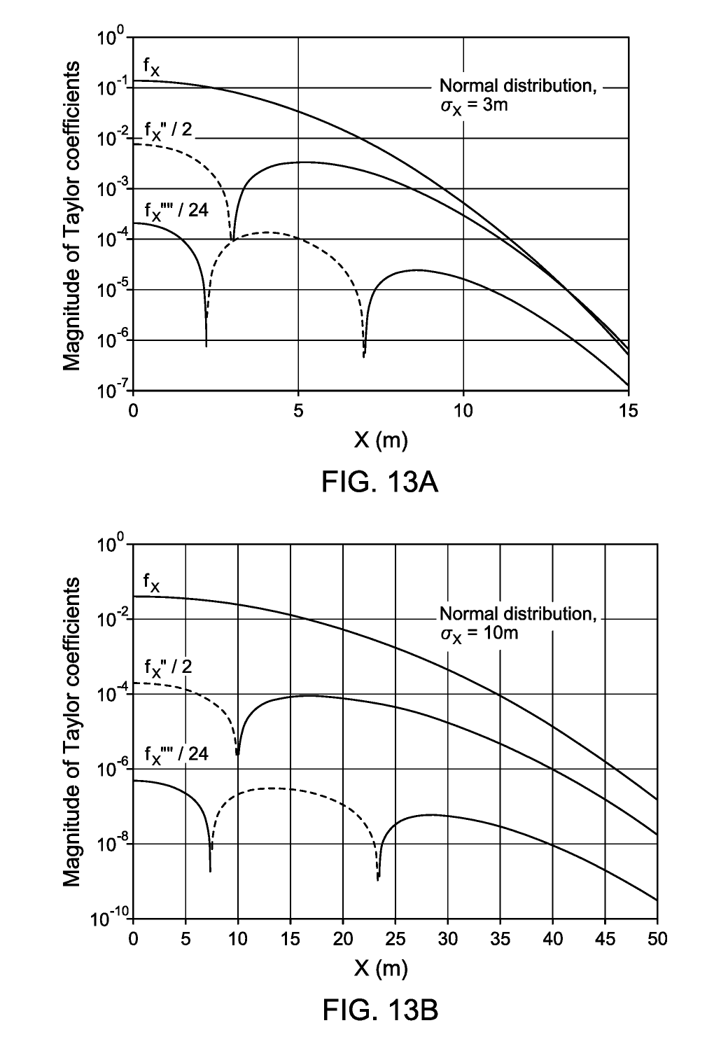

Taylor series terms of 4^{th} order or higher are neglected in this analysis. This is justified by FIGS. 13A-13B, which indicates that the 4^{th} order coefficients such as ƒ_{X}″″/(4!) are insignificant compared to 0^{th} and 2^{nd} order coefficients, for moderate and large a values. FIGS. 13A-13B illustrate graphical plots of Taylor coefficients for a multiple wellbore environment in accordance with implementations of various techniques described herein. However, no definitive conclusions should be drawn, because FIGS. 13A-13B are restricted to a 1D PDF, segment dimensions and wellbore separations have not been included, and the integral over the segment's volume has not been considered. Furthermore, 4^{th} order cross term coefficients such as ƒ_{X}″ƒ_{Y}″/(2! 2!) can only be inferred from the 2^{nd} order term ƒ_{X}″, by evaluating the cross term over the XY plane. In particular, FIGS. 13A-13B illustrate magnitudes of 0^{h}, 2^{nd}, and 4^{th} order Taylor coefficients as a function of evaluation point x, for a 1D normal distribution f_{X} with mean 0, and where σ=3 m corresponds to FIG. 13A and σ=10 m corresponds to FIG. 13B. The dashed curve sections indicate the regions where the 2^{nd} and 4^{th} order coefficients are negative.

The probability that point M_{R} intersects segment j (direct hit collision) can therefore be approximated as:

$${P}_{DH , MR} ( j ) \approx {f}_{X} {f}_{Y} {f}_{Z} π {R}_{1} {R}_{2} L + ( {f}_{X}^{″} {f}_{Y} {f}_{Z} + {f}_{X} {f}_{Y}^{″} {f}_{Z} + {f}_{X} {f}_{Y} {f}_{Z}^{″} ) \frac{π}{8} {R}_{1}^{4} L \qquad ( 42 )$$

where R₁, R₂, and L are given by equations 21, 22, and 40. The 1D PDFs ƒ_{X}, ƒ_{Y}, and ƒ_{Z}, and their second derivatives ƒ_{X}″, ƒ_{Y}″, and ƒ_{Z}″ must be evaluated at the segment's centre (xⱼ, yⱼ, zⱼ), using probability density distribution functions with the respective standard deviations σ_{X}, σ_{Y}, and σ_{Z}.

For a normal distribution, the 1D PDF is:

$${f}_{X , norm} ( x ) = \frac{1}{\sqrt{2 π} {σ}_{X}} {e}^{- {x}^{2} / 2 {σ}_{X}^{2}} \qquad ( 43 )$$

and its 2^{nd} order derivative is:

$${f}_{X , norm}^{″} ( x ) = ( \frac{{x}^{2} - {σ}_{X}^{2}}{{σ}_{X}^{4}} ) \frac{1}{\sqrt{2 π} {σ}_{X}} {e}^{- {x}^{2} / 2 {σ}_{X}^{2}} \qquad ( 44 )$$

However, the derivation of Equation 42 has not made any assumption regarding the probability density distribution functions. Equation 42 can therefore be evaluated using any reasonable (e.g., bell-shaped) distribution function that is centered on the point M_{R}, and that has a well-defined Taylor expansion series, or at least a continuous second derivative that can be evaluated analytically or numerically.

The total probability that point M_{R} hits somewhere on the offset wellbore section is found by summing Equation 42 over all segments j=1 . . . J.

### Direct Hit Probability—Interval Versus Section Scenario

The contents of this section is an extended and more detailed description of the procedure that has earlier been described with respect to FIG. 5.

The DH probability per reference wellbore interval, P_{DH,ΔMD}, can be assessed by considering the relative motion of the offset wellbore with respect to the drill bit. The interval would typically be the interval drilled between two survey stations, i.e., a length of 10-30 m. However, in the general 3D situation, prior art approaches may lead to high conceptual and computational complexity.

The DH probability given by Equation 42 is derived by considering a single point M_{R} in the reference wellbore. The division of the offset wellbore into short segments j of length L is retained in the following. By evaluating Equation 42 for all segments j of the offset wellbore, at multiple points similar to M_{R} at short intervals along the reference wellbore, a dense sampling of the direct hit probability can be obtained along both wellbores. P_{DH,ΔMD} can be estimated from these results. The integration in prior art approaches is then approximated through summation of piecewise linear contributions. This overcomes the complexity associated with a general geometry in a general scenario, and makes the analytic calculation of the DH probability feasible also for such general geometries.

At one point M_{R} in the reference wellbore, consider the local ξψζ system, where ξ is the along-hole coordinate, and ψ and ζ are coordinates defining a perpendicular plane (FIG. 14). FIG. 14 illustrates that, as drilling advances the reference wellbore the small distance dξ of the interval from M₁ to M₂, segment j in the offset wellbore moves dξ in the opposite direction, relative to the drill bit. The lower part of FIG. 14 shows the projection of the segment j when seen in the along-hole (ξ) direction. The elliptical ends of the projection represent the projected areas of segment j that overlap with segments j−1 and j+1. Any overlap with segment j−1 or segment j+1 must be excluded. Half of either ellipse area is therefore assigned to segment j, creating a projected width equal to L sin(β_{MR,j}). Viewed along the ξ axis, segment j will therefore have projected height 2R₁ and projected width L sin(β_{MR,j}). The path from M₁ to M₂ needs not be straight; hence β may vary over this interval. When drilling the short distance dξ, the probability of hitting segment j is

dP_{DH,dξ}(j)=ƒ̅_{MR}(j)dV=(P_{DH,MR}(j)/V_{MR}(j))2R₁L sin(β_{MR,j})dξ (45)

where ƒ̅_{MR}(j) is the ratio between P_{DH,MR}(j) (Equation 42) and V_{MR}(j) (Equation 23). This ratio becomes an average PDF value that is valid across segment j. Both P_{DH,MR}(j) and V_{MR}(j) vary with through their dependency on the local angle β_{MR,j}(ξ). The average PDF value is multiplied by the volume element dV=2R₁L sin(β_{MR,j})dξ that is covered by segment j moving the along-hole distance dξ. Because the volumes dV and V_{MR}(j) relate to the same segment, and therefore have the same dimensions, Equation 45 implies no significant change to the probability accuracy compared to Equation 42. The hitting probability for segment j when drilling an interval from M₁ to M₂ is found by integrating Equation 45 along the along-hole (ξ) axis over the interval:

P_{DH,M1M2}(j)≈2R₁L∫_{M1}^{M2}[P_{DH,MR}(j)/V_{MR}(j)]sin[β_{MR,j}(ξ)]dξ (46)

The above procedure, which implies a reduction of a 3D problem to 1D, can be justified because the 3D PDF's variation across the along-hole path traced out by segment j (i.e., the PDF's variation in transversal dimensions ψ and ζ) has been taken care of through the Taylor series expansion. Therefore, to a good approximation, all the parameters P_{DH,MR}(j), V_{MR}(j), and β_{MR,j} that constitute the integrand, depend on the along-hole position ξ only. Moreover, both the ratio P_{DH,MR}(j)/V_{MR}(j) and the factor sin(β_{MR,j}) can be expected to vary relatively slowly with ξ. Over a small analysis interval ΔMD_{M1M2} from M₁ to M₂, the integral in Equation 46 can therefore be approximated by a trapezoid area such that

$${P}_{DH , M 1 M 2} ( j ) \approx 2 {R}_{1} L [ \frac{{P}_{DH , M 1} ( j ) sin ( {β}_{M 1 , j} )}{{V}_{M 1} ( j )} + \frac{{P}_{DH , M 2} ( j ) sin ( {β}_{M 2 , j} )}{{V}_{M 2} ( j )} ] ( Δ {MD}_{M 1 M 2} / 2 ) \qquad ( 47 )$$

ΔMD_{M1M2} must be small enough that the effects of the non-linearity of the integrand in Equation 46 are negligible. A calculation example indicates that this can be obtained with ΔMD_{M1M2}≈0.1-1 m. Over reference wellbore sections of a few hundred meters, the computation time will be acceptable even for the smallest of these values. However, more testing would be needed to determine the recommended length ΔMD_{M1M2} of the analysis interval for various scenarios, and the effect of this length on the P_{DH} accuracy.

Equation 47 must be summed over all segments j to account for the whole offset wellbore, and over the appropriate analysis intervals along the reference wellbore to give P_{DH,ΔMD} over a reference wellbore section of for example 30 m.

When β→0, the DH probability per interval, as expressed by Equation 47, approaches zero. This is a consequence of the idealized model; when the wellbores become parallel, they cannot intersect. One requirement for realistic results is that the relative position uncertainty changes (increases) with MD. In combination with this, the following practical approach might be considered: The drilling and surveying operations will, individually or in combination, impose a lower limit Δβ₀ to the precision with which β can be drilled and measured. Δβ₀ can normally be estimated from survey-error analysis and knowledge of the drilling operation. Therefore, Equation 47 with β=Δβ₀ and summed over offset wellbore segments and reference wellbore analysis intervals may be regarded as a lower limit to the probability. This lower limit value might replace the total probability (summed over segments and intervals) from Equation 47 with actual and near-parallel β values, whenever the latter result becomes smaller than the lower limit value.

### Unintentional Crossing (UC) Probability

The contents of this section are an extended and more detailed description of the procedure that has earlier been described with respect to FIG. 6.

With respect to determining the unintended crossing probability, the following operations, which are all related to transformations between coordinate systems, will be used. The procedures are described for vectors and matrices in 3D. The corresponding 2D procedures are obtained by ignoring the Z and V coordinates.

The variance along one of the coordinate axes of a 3D covariance matrix Σ is obtained by deleting all Σ elements that involve the other two axes. For example, σ_{X}² is obtained from Σ_{XYZ} by deleting the “Y” and “Z” rows and columns. Similarly, the 2D covariance matrix in one of the planes given by two of the coordinate axes (e.g. Σ_{XY}) is obtained by deleting the third dimension (Z) from Σ_{XYZ}. These operations correspond to projecting the matrix (or ellipsoid) onto the coordinate axis, or onto the coordinate axes plane.

If a covariance matrix is initially given in another coordinate system (e.g., NEV), it can be expressed in the desired coordinate system (XYZ) by use of the coordinate-transformation matrix T_{NtoX}:

Σ_{XYZ}=T_{NtoX}Σ_{NEV}T_{NtoX}^{T} (51)

The superscript T denotes the matrix (and later, the vector) transpose. The NEV and XYZ systems must share a common origin. T_{NtoX} is constructed from vectors that define the new coordinate system:

$${T}_{NtoX} = [ \begin{matrix}{u}_{X}^{T} \\ {u}_{Y}^{T} \\ {u}_{Z}^{T}\end{matrix} ] \qquad ( 52 )$$

where u_{X} is a column vector that is parallel to the X axis, and so forth. These vectors must have unit length, and must be described in the existing (NEV) system: u_{X}^{T}=[n_{uX} e_{uX} v_{uX}], and so forth. T_{NtoX} also provides the position data transformations between the two coordinate systems, e.g., for a general column vector w:

w_{XYZ}=T_{NtoX}w_{NEV} (53)

For orthogonal transformations, which is the only type of transformation applied with respect to the implementations herein, the inverse transformation matrix T_{XtoN}=T_{NtoX}⁻¹ equals T_{NtoX}^{T}.

The example in FIGS. 10A-10B indicated that the planar boundary imposed by the pedal-surface method for a single pair of points may be insufficient to address the UC probability properly, if the offset wellbore is curved. It is therefore suggested here to substitute the planar “wall” with a “fence”, where individual “bars” can be moved towards or away from the reference-well point M_{R}, in accordance with the direction-dependent distance to various points along the offset wellbore. The two approaches are illustrated for a 3D scenario in FIGS. 15A-15B. FIGS. 15A-15B illustrate schematic diagrams relating to unintentional crossings in a multiple wellbore environment in accordance with implementations of various techniques described herein. For the “fence” approach, it is necessary to carry out the analysis in a cylindrical coordinate system RΘZ, which results from a Cartesian system XYZ with orientation given by the offset wellbore section and the point M_{R}. The two systems have the same Z axis and the same origin at M_{R}. These systems are illustrated in FIGS. 16A-16B. FIGS. 16A-16B illustrate schematic diagrams relating to unintentional crossings in a multiple wellbore environment in accordance with implementations of various techniques described herein.

FIGS. 15A-15B illustrate two realizations of an unwanted region boundary (cross-hatched) between a point M_{R} on the reference wellbore, and the offset wellbore. Both wells may be 3D trajectories. In FIG. 15A, the direction D₁ is assumed to be identified by the closest approach or the perpendicular scan methods, or by a similar method. By the pedal curve (pedal surface) approach, the boundary is established as a planar “wall” perpendicular to D₁, i.e., parallel to the plane given by D₂ and D₃. In FIG. 15B, the alternative approach proposed here uses the predominant direction of the offset wellbore and the point M_{R} to define the X and Y axes of a particular XYZ coordinate system. This allows for a “fence” boundary with individual “bars” (parallel to the Z axis) positioned along the offset wellbore. The “bars” should touch each other such that the “fence” becomes a continuous surface. Both the “wall” and the “fence” extend to infinity along two dimensions. Wellbore cross-section dimensions and possible additional distance margins have been neglected in the figure.

FIGS. 16A-16B illustrate the coordinate systems applied in the analysis. Both wells may be 3D wellbores. The XY plane is defined by the point M_{R} and a regression line Y′-Y′ that is fitted through a number of original (i.e. not interpolated) offset wellbore positions. The projection of the combined 3D ellipsoid (solid) onto the XY plane becomes the 2D ellipse (dashed). The 3D offset wellbore may be also projected onto the XY plane, or the calculations may be performed in any other plane parallel to the XY plane, for example in a particular plane given by a particular point on the offset wellbore. The Cartesian coordinate system XY is converted into the polar coordinate system RO, and the plane is divided into narrow sectors, as indicated by the dashed lines. This will further convert the XYZ coordinate system into a cylindrical coordinate system RΘZ, and a division of the volume into narrow wedges that project onto the XY (RΘ) plane as the narrow sectors. The boundary at Dⱼ within sector j constitutes “bar j” of the “fence”, and the cross-hatched area (defined by rⱼ>Dⱼ) is the unwanted region of sector j. The various θ angles are explained later. Wellbore cross-sectional dimensions and possible additional distance margins between the wells have been neglected in the figure.

The following steps will define the coordinate systems: A straight regression line Y′-Y′ is fitted through a set of original (i.e. not interpolated) offset wellbore positions (FIG. 16A). The number of such offset wellbore positions will be denoted by Q. These positions may cover the full offset wellbore section used in the analysis, or they may cover only a shorter (central) part of the section. The purpose of the Y and X axes is solely to define the XY plane such that the 3D offset wellbore section lies “as close as possible” to the plane. This is most desirable for the central part of the section, where the contributions to the total P_{UC} from each segment are highest. As a guideline, it is suggested that positions (survey stations) closer to M_{R} than about 4-5σ should be included in the regression fit, assuming a normal PDF. This may be revised, depending on empirical experience with the method in various scenarios, such as various 3D shapes and curvatures of the offset wellbore, or non-normal PDFs. For low and moderate curvatures, even a small number of original positions (e.g., 3-5) will exhibit a predominant wellbore directionality, manifested as one dominating eigenvalue for the S matrix below; hence, such a limited set may still define a Y′-Y′ direction that is adequate for the further analysis.

The regression line results from a principal component analysis, and is given by the eigenvector corresponding to the largest eigenvalue of:

$$S = [ \begin{matrix}{\sum }_{q = 1}^{Q} {( {n}_{q} - \overline{n} )}^{2} & {\sum }_{q = 1}^{Q} ( {n}_{q} - \overline{n} ) ( {e}_{q} - \overline{e} ) & {\sum }_{q = 1}^{Q} ( {n}_{q} - \overline{n} ) ( {v}_{q} - \overline{v} ) \\ {\sum }_{q = 1}^{Q} ( {e}_{q} - \overline{e} ) ( {n}_{q} - \overline{n} ) & {\sum }_{q = 1}^{Q} {( {e}_{q} - \overline{e} )}^{2} & {\sum }_{q = 1}^{Q} ( {e}_{q} - \overline{e} ) ( {v}_{q} - \overline{v} ) \\ {\sum }_{q = 1}^{Q} ( {v}_{q} - \overline{v} ) ( {n}_{q} - \overline{n} ) & {\sum }_{q = 1}^{Q} ( {v}_{q} - \overline{v} ) ( {e}_{q} - \overline{e} ) & {\sum }_{q = 1}^{Q} {( {v}_{q} - \overline{v} )}^{2}\end{matrix} ] \qquad ( 54 )$$

where n_{q}, e_{q}, and v_{q} for q=1 . . . Q are north, east, and vertical coordinates of the set of Q offset wellbore positions. The regression line passes through the center of gravity (n̅, ē, v̅) of the Q positions, given by the arithmetic means

$$\overline{n} = \frac{1}{Q} {\sum }_{q = 1}^{Q} {n}_{q} \overline{e} = \frac{1}{Q} {\sum }_{q = 1}^{Q} {e}_{q} \overline{v} = \frac{1}{Q} {\sum }_{q = 1}^{Q} {v}_{q} \qquad ( 55 )$$

The Y axis is the regression line vector translated to the origin M_{R}. The same Y′-Y′ regression line may be used for several points M_{R} along the reference wellbore, if the overall geometry justifies that the same offset wellbore section is selected for each of these points.

The X axis is the line projecting M_{R} onto the regression line Y′-Y′. If the regression line lies too close to M_{R}, such that the XY plane's orientation is ill-defined or the subsequent division of the plane into sectors becomes impractical, the regression line should be recalculated from a different, but still representative, selection of offset wellbore positions.

The Z axis results from the cross product of the unit vectors (denoted u) along the X and Y axes:

u_{Z}=u_{X}×u_{Y} (56)

The (x, y) coordinates are further converted into polar coordinates (r, θ) through the familiar relations:

r=\sqrt{x²+y²} θ=arctan(y/x) (57)

The ± directions of the XYZ system and the reference direction θ=0 of the polar system are not essential for the further analysis, as long as the coordinate systems are consistently defined. It is here assumed that: a) the XYZ system is right-handed; b) the central section of the offset wellbore (i.e., the section that is closest to M_{R}) has positive X coordinates; c) the θ=0 direction corresponds to the X axis.

The RΘ plane is now divided into narrow sectors j (j=1 . . . J), which implies the division of space into corresponding wedges (FIG. 16B). The opening angles Δθⱼ of each sector/wedge may be different for different sectors/wedges, or a constant value may be applied for all Δθⱼ. Each Δθⱼ should be so small that the variation of the PDF across each sector/wedge is negligible; implying that the mid plane (the RⱼZ plane) is representative for the wedge. Test calculations have indicated that for ellipse aspect ratios σ₁/σ₂ up to around 10, the final P_{UC} is accurately estimated and insensitive to Δθⱼ when applying a constant opening angle Δθⱼ=Δθ_{const}≤0.5°; however, this value should be verified through further testing of the method. The total number J of wedges is determined by the total angular span of θ between the ends of the offset wellbore section, as seen from the point M_{R}. Typically, this span can be expected to be in the range from 90° to 180°; however, it may exceed 180° if the offset wellbore section curves around M_{R}.

Through the above definitions, a cylindrical coordinate system RΘZ is established where: a) the origin is at point M_{R}; b) the offset wellbore (which may be in 3D) lies close to the RΘ plane; c) the offset wellbore cuts approximately perpendicularly through the wedges when it is closest to M_{R}.

For all wedges j (j=1 . . . J), the offset wellbore position and covariance matrix will be needed at the point (xⱼ, yⱼ, zⱼ) where this well intersects the RⱼZ plane. This point is found by describing the offset wellbore in a Cartesian system XⱼYⱼZ that is rotated around the Z axis by the angle θⱼ from the XYZ system, such that Xⱼ coincides with Rⱼ. In the XⱼYⱼZ system, the intersection of the offset wellbore with the XⱼZ (RⱼZ) plane is found through interpolating to yⱼ=0. This gives the coordinates rⱼ=xⱼ(yⱼ=0) and z=zⱼ(yⱼ=0) for the intersection point.

As indicated in FIGS. 16A-16B, the offset wellbore section of interest may be projected onto the XY plane. It is equally possible to perform the further analysis in a plane parallel to the XY plane, for example in the plane located at z=zⱼ along the Z axis. To have a precise definition of the “fence” boundary and hence of V_{UC}, it is reasonable to define the “fence” as following the offset wellbore's projection in the XY plane (FIG. 15B) and continuing to infinity in the directions of the projected section's tangents at the end points of the offset wellbore section.

Furthermore, the combined 3D covariance matrix (uncertainty ellipsoid) is projected onto the XY (RΘ) plane, yielding the 2D covariance matrix Σ_{XY}. This step, which is necessary to obtain an analytic solution, implies that possible X-Z and Y-Z correlations are ignored. The reduction to a 2D model can be partly justified by the fact that the offset wellbore, and hence, the direction vector from M_{R} to any point on the offset wellbore, lies close to the XY plane. The projection leads to the suggested “fence”, with “bars” (one within each wedge) parallel to the Z axis and stretching to ±∞ in the Z direction.

The PDF associated with Σ_{XY} must be expressed in the RΘ system. This is demonstrated here for a normal 2D PDF. It may be possible to obtain similar analytic solutions for alternative bell-shaped distributions; this should be subject to further investigation.

For a normal 2D distribution with a circular confidence region (σ_{X}²=σ_{Y}²=σ_{R}² and cov(X, Y)=0), the RΘ PDF factorizes into

ƒ_{RΘ,circ}(r,θ)=ƒ_{R,circ}(r)ƒ_{Θ,circ}(θ) (58)

where ƒ_{R,circ}(r) is the Rayleigh distribution:

$${f}_{R , circ} ( r ) = \frac{1}{{σ}_{R}^{2}} r {e}^{- {r}^{2} / 2 {σ}_{R}^{2}} for r \geq 0 \qquad ( 59 )$$

and ƒ_{Θ,circ}(θ) is the uniform distribution:

ƒ_{Θ,circ}(θ)=1/2π (60)

This factorization of the RΘ PDF will be adopted in the following, however with Equations 59-60 replaced by ƒ_{R} and ƒ_{Θ} distribution functions that sample the true ƒ_{RΘ}(r, θ) distribution (i.e., the distribution with possibly elliptic confidence region) within each sector. This procedure means that the factorization only implies the neglect of correlations between r and θ coordinates within one sector, not between the sectors. The resulting orthogonality between the R and Θ directions implies that the ƒ_{R} and ƒ_{Θ} distribution functions can be integrated separately; hence for each sector (wedge) j, the UC probability can be evaluated as:

P_{UC}(j)≈∫ᵣ_{₁}^{r}^{₂}ƒ_{R,j}(r)dr∫_{θ}_{₁ⱼ}^{θ}^{₂ⱼ}ƒ_{Θ}(θ)dθ=P_{R,j}(r₁,r₂)P_{ΔΘ}(θ₁ⱼ,θ₂ⱼ) (61)

where P_{ΔΘ}(θ₁ⱼ, θ₂ⱼ) is the probability of being between the angles θ₁ⱼ and θ₂ⱼ that define the extension (opening angle) of the sector/wedge in the RΘ plane (FIG. 16B), and P_{R,j}(r₁,r₂) is the probability of being more than r₁ and less than r₂ away from the origin in the radial direction, within sector/wedge j.

Ideally, the initial offset wellbore uncertainty (at surveyed stations) should be interpolated to the intersection point (xⱼ, yⱼ, zⱼ) with each sector's RⱼZ plane (j=1 . . . J) before being combined with the reference wellbore uncertainty in point M_{R}, then projected onto the XY (RΘ) plane, and finally applied in Equation 61. This may require repeated coordinate transformations (Equations 51-53) back and forth between the NEV, the XYZ, and the XⱼYⱼZ systems. These procedures are not detailed further here. However, because Σ_{XY} thereby becomes a function of j along the offset wellbore, the sum of Equation 61 over all sectors will not be normalized (the sum over the entire plane will not equal exactly 1). The effect on the total P_{UC} (Equation 16) is assumed to be small; however, this must be verified through testing. If such verification indicates that the effect is not negligible, the outcome of Equation 61 may need to be normalized before the final summation over j.

An alternative, approximate solution would be to ignore the development of the offset wellbore uncertainty over the section being studied, and use for example the covariance matrix in the point closest to M_{R} as representative for the whole section. In this way, Σ_{XY} becomes constant and some algorithmic complexity can be avoided. However, the effect of this approach on the resulting P_{UC} would also need to be investigated for various realistic cases.

With the exception of a constant coefficient, Equation 59 is the derivative of a normal PDF for r. This means that the probability of being beyond a particular distance Dⱼ in the Rⱼ direction is

$${P}_{R , j} ( r > {D}_{j} ) = {\int }_{{D}_{j}}^{∞} \frac{1}{{σ}_{R , j}^{2}} r {e}^{- {r}^{2} / 2 {σ}_{R , j}^{2}} dr = {e}^{- {D}_{j}^{2} / 2 {σ}_{R , j}^{2}} \qquad ( 62 )$$

In Equation 62, σ_{R,j} is the ellipse radius in the Rⱼ direction, and does not relate to the pedal curve/surface. This is because the integral is evaluated within sectors with various orientations in the plane, in contrast to the 1D integral in Equation 17. Dⱼ is the radial distance in the RΘ plane between M_{R} and the “bar” that defines the unwanted region's boundary within wedge j. Dⱼ may for example be defined similar to Equation 10, with the center-to-center distance D_{RO}=xⱼ=rⱼ [the projection of (xⱼ, yⱼ, zⱼ) onto the Rⱼ axis]. Any modification such as Equation 22 (for the DH probability) to the combined radii will have much smaller relative significance for P_{UC}. Furthermore, reducing Dⱼ by the straight-forward combination R_{R}+R_{O} provides a conservative value for the distance. Furthermore, D₁ may be reduced by additional distance amounts other than R_{R} and R_{O}, to provide additional distance safety margin between the two wellbores.

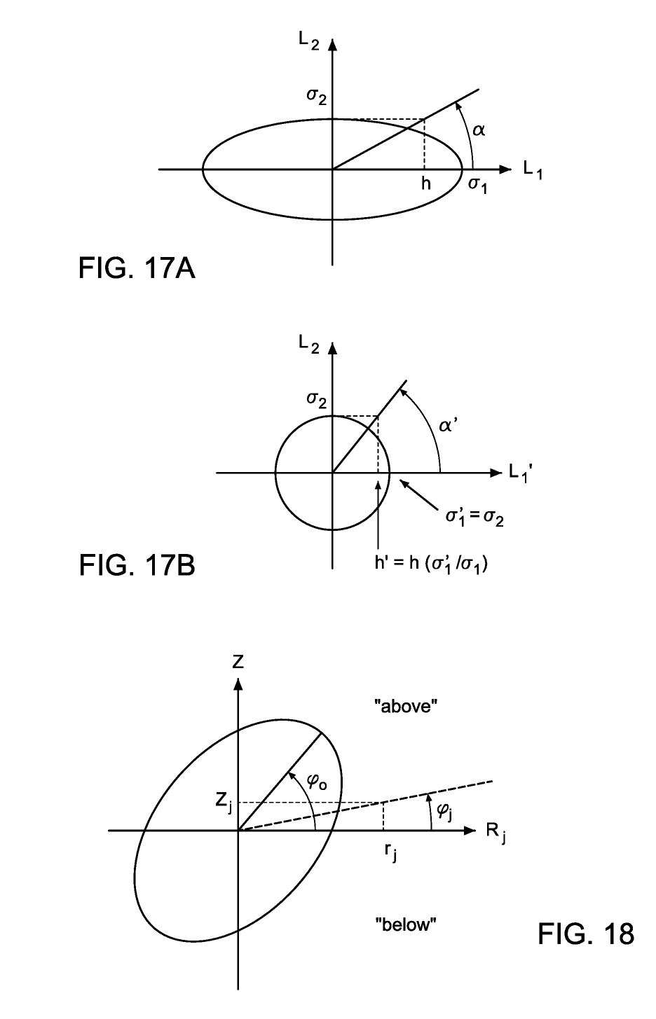

The θ distribution function ƒ_{Θ} is no longer uniform like Equation 60, because of the elliptic shape of the 2D PDF. However, the integral of ƒ_{Θ} over a certain angle α (measured from the ellipse's long axis) can be found from FIGS. 17A-17B. FIGS. 17A-17B illustrate a normalization of axes to a common σ unit; a) The 1σ ellipse is described in the L₁L₂ coordinate system given by its principal axes; and b) Compressing the L₁ axis by the factor σ₂/σ₁ changes the ellipse into a circle, and changes σ₁ into σ₁′, h into h′, and α into α′. In one implementation, only the transformation of the 2D (RΘ) distribution function may be applied, and the well paths or space itself are not affected. Under this transformation, the probability P_{Θ}(α) of being within the sector with opening angle α is the same as P_{Θ,circ}(α′) for the distorted angle α′:

P_{Θ}(α)=P_{Θ,circ}(α′)=α′/2π (63)

By use of the relations h′/σ₁′=h/σ₁ and σ₁′=σ₂, this leads to

$${P}_{Θ} ( α ) = arctan [ ( {σ}_{1} / {σ}_{2} ) tan ( \vert α \vert ) ] / 2 π for α ∈ [ \frac{- π}{2} , \frac{π}{2} ] \qquad ( 64 )$$

Instead of using Equation 64 directly, we shall define a new function G_{Θ}(α) by

$${G}_{Θ} ( α ) = arctan [ ( {σ}_{1} / {σ}_{2} ) tan ( \vert α \vert ) ] / 2 π for α ∈ [ \frac{- π}{2} , \frac{π}{2} ] \qquad ( 65 )$$

The only change from P_{Θ}(α) is that the absolute value function is not applied to α. G_{Θ}(α) can therefore be negative, and this implies that the P_{ΔΘ} function in Equation 61 can be found simply as the difference between G_{Θ} functions, as will be shown below.

Because α is defined with respect to the ellipse's long axis, the symmetry of the ellipse implies:

G_{Θ}(nπ/2)=n/4 for integer n (66)

G_{Θ}(−α)=−G_{Θ}(α) (67)

G_{Θ}(α)+G_{Θ}(π−α)=½ (68)

G_{Θ}(α+π)=G_{Θ}(α)+½ (69)

These properties may be used when the initial α value is outside the range [−π/2, π/2] for which the tangent function in Equation 65 is continuous.

The input to the G_{Θ} function should always be an angle referenced to the ellipse's long axis. The long axis of the ellipse makes an angle θ₀ with the X-axis (see FIGS. 16A-16B), given by:

$${θ}_{0} = \frac{1}{2} arctan ( \frac{2 cov ( X , Y )}{{σ}_{X}^{2} - {σ}_{Y}^{2}} ) \qquad ( 70 )$$

The two sector boundaries θ₁ⱼ and θ₂ⱼ in FIG. 16B therefore make the angles

α₁ₗ=−θ₀+θ₁ⱼ=−θ₀+θⱼ−^{Δθ}^{ⱼ}/2 (71)

α₂ⱼ=−θ₀+θ₂ⱼ=−θ₀+θⱼ+^{Δθ}^{ⱼ}/2 (72)

with the ellipse's long axis. These angles may need to be constrained to the range [−π/2, π/2] by Equations 66-69. The probability of being within the sector that is bounded by the angles becomes

P_{ΔΘ,rel X axis}(θ₁ⱼ,θ₂ⱼ)=P_{ΔΘ,rel long axis}(α₁ⱼ,α₂ⱼ)=|G_{Θ}(α₁ⱼ)−G_{Θ}(α₂ⱼ)| (73).

Finally, it is possible to estimate the probability that point M_{R} crosses “above” or “below” the offset wellbore, within each wedge j (FIG. 18). This distinction may be particularly useful when the drilling approaches an offset wellbore from a distance. The terms “above” vs. “below” here mean “at z>zⱼ” vs. “at z<zⱼ”, respectively, and should be interpreted as “left” vs. “right”, “north” vs. “south”, and so forth with respect to the offset wellbore, depending on the drilling direction and on the orientation of the RΘZ coordinate system with respect to the global NEV system. FIG. 18 illustrates relations between angles in the RⱼZ plane, for determination of the “above” and “below” crossing probabilities. The ellipse in FIG. 18 is the projection of the 3D ellipsoid onto the RⱼZ plane. This ellipse has its long axis at an angle φ₀ with the Rⱼ axis. The dashed line at angle φⱼ with the Rⱼ axis goes from the origin through the intersection point (rⱼ, zⱼ) of the offset wellbore with the RⱼZ plane. Hence, the dashed line divides the r>0 region into the desired regions “above” and “below” the point (rⱼ, zⱼ). Wellbore cross-section dimensions are neglected in the figure.

The analysis applies the Cartesian coordinate system XⱼYⱼZ, where the Xⱼ-axis coincides with the Rⱼ-axis. The 2D covariance matrix Σ_{X}_{ⱼ}_{Z} is obtained by projecting Σ_{X}_{ⱼ}_{Y}_{ⱼ}_{Z} onto the XⱼZ (RⱼZ) plane. The probabilities P_{a,j} of being “above”, respectively P_{b,j} “below” the point (rⱼ, zⱼ) within wedge j, are, by applying the G_{Θ} function to the φ angle in the RⱼZ plane:

P_{a,j}=P_{ΔΘ}(φⱼ,π/2)=|G_{Θ}(π/2−φ₀)−G_{Θ}(φⱼ−φ₀)| (74)

P_{b,j}=P_{ΔΘ}(−π/2,φⱼ)=½−P_{a,j} (75)

where Equation 74 is analogous to Equation 73, φ₀ is the angle of the long axis from the Rⱼ axis (FIG. 18; found analogous to Equation 70), and φⱼ is the angle between the Rⱼ axis and the direction from the origin to the offset wellbore's intersection point (rⱼ, zⱼ)=(xⱼ, zⱼ) with the RⱼZ plane, given by

φⱼ=arctan(zⱼ/rⱼ) (76)

Equation 74 includes the entire half plane r>0 of FIG. 18. A more accurate, but also more complicated, solution might consider only the region r>rⱼ.

P_{a,j} and P_{b,j} can be combined into normalized weighting factors w_{a,j} and w_{b,j}:

w_{a,j}=P_{a,j}/[P_{a,j}+P_{b,j}] w_{b,j}=P_{b,j}/[P_{a,j}+P_{b,j}] (77)

which by Equation 75 can be simplified to w_{a,j}=2P_{a,j} and w_{b,j}=2P_{b,j}. The weighting factors divide the P_{UC}(j) result for each sector/wedge j (Equation 61) into the “above” and “below” probabilities P_{UC,a}(j) and P_{UC,b}(j), respectively:

P_{UC,a}(j)=w_{a,j}P_{UC}(j) P_{UC,b}(j)=w_{b,j}P_{UC}(j) (78)

Equation 61, or each equation of Equation 78, should be summed over all sectors/wedges j=1 . . . J according to Equation 16, to give the total UC probability, respectively the total “above” and “below” UC probabilities, of an unintentional crossing with the entire offset wellbore section.

The procedures described above and illustrated in FIGS. 15B, 16A, 16B, 17, and 18, are not restricted to the particular XYZ coordinate system that is derived from the offset wellbore section and the point M_{R}, as described above and illustrated in FIG. 16A. The procedures can be applied in any other Cartesian coordinate system XYZ with any orientation and location with respect to the two wellbores. The orientation and location of such a coordinate system may be chosen based upon the purpose of the analysis, and based upon further features of the wells, of the position uncertainties, and of the downhole and reservoir environment such as fluid contacts, stratigraphic layer boundaries, high-pressure zones, or faults.

In sum, implementations described herein may be used to determine direct hit or unintentional crossing probabilities for wellbores. In particular, the implementations described herein may be used to determine more accurate direct hit or unintentional crossing probabilities between a reference wellbore and an offset wellbore when compared to other methods. Moreover, the implementations described herein may be used to determine more accurate direct hit or unintentional crossing probabilities for arbitrary well geometries and uncertainty-ellipsoid orientations.

In comparison to methods used in the prior art, the implementations described herein provide more accurate direct hit or unintentional crossing probabilities for wellbores. For example, one prior art approach is to analyze the collision probability between two points, one in each wellbore, that are determined from geometric criteria only. This procedure may ignore point pairs with higher collision probabilities, and thereby lead to over-optimistic conclusions. Typically, the results from such methods will be accurate only for simple wellbore geometries, such as straight sections, and for position uncertainties that are highly symmetrical with respect to the wellbores. More advanced methods that overcome such limitations are impractical for general application because of high conceptual or computational complexity. In contrast, the implementations described herein overcome these issues by determining cells (e.g., segments, sectors, and wedges) for the spatial region of interest, such that the collision probability can be accurately evaluated for each cell. The total collision probability is then found by summing the results over all cells. As such, the implementations described herein provide accurate results for arbitrary well geometries and uncertainty ellipsoid orientations.

As noted above, the collision probabilities determined using the implementations described herein may be evaluated in the well planning phase and at critical stages during the drilling phase. In particular, a drilling operator may use these probabilities to make decisions on whether to follow or alter the drilling plan, such as in real-time (i.e., during drilling). In some scenarios, the drilling operator may accept a higher probability of a low-consequence collision (e.g., a purely financial loss) than of a high-consequence collision (e.g., a serious health, safety, or environmental related outcome). Specifically, a drilling operator may use a determination of the direct hit probability when making decisions regarding drilling, as a direct hit event between the wellbores may, as explained above, lead to significant economic, environmental, and health and safety consequences. In addition, a drilling operator may use a determination of the unintentional crossing probability when making decisions regarding drilling, as an unintentional crossing may indicate a relatively low knowledge of the relative positions of the wellbores, and may potentially lead to a direct hit if a decision is made to steer the reference wellbore in a presumably safe direction. For some implementations, it can be said that the direct hit or unintentional crossing probabilities may be used for the purposes of, for example: drilling the reference wellbore based on the plurality of direct hit and/or unintentional crossing probabilities, providing assistance for drilling the reference wellbore based on the plurality of direct hit and/or unintentional crossing probabilities, causing the reference wellbore to be drilled based on the plurality of direct hit and/or unintentional crossing probabilities, and/or the like.

### Computing System

Various implementations of computing systems are further discussed below, including computing system 130 of FIG. 1. Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, smart watches, personal wearable computing systems networked with other computing systems, tablet computers, and distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. While program modules may execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. The distributed computing environments may span multiple continents and multiple vessels, ships or boats. In a distributed computing environment, program modules may be located in both local and remote computer storage media including memory storage devices.

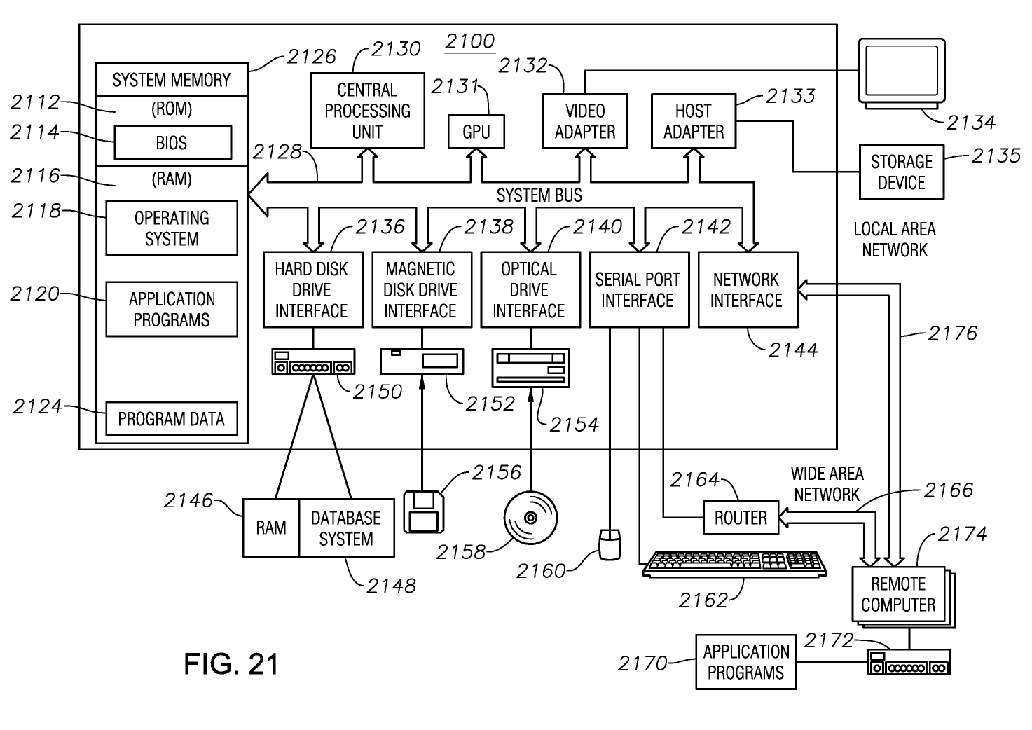

FIG. 21 illustrates a schematic diagram of a computing system 2100 in which the various technologies described herein may be incorporated and practiced. Although the computing system 2100 may be a conventional desktop or a server computer, as described above, other computer system configurations may be used.

The computing system 2100 may include a central processing unit (CPU) 2130, a system memory 2126, a graphics processing unit (GPU) 2131 and a system bus 2128 that couples various system components including the system memory 2126 to the CPU 2130. Although one CPU is illustrated in FIG. 21, it should be understood that in some implementations the computing system 2100 may include more than one CPU. The GPU 2131 may be a microprocessor specifically designed to manipulate and implement computer graphics. The CPU 2130 may offload work to the GPU 2131. The GPU 2131 may have its own graphics memory, and/or may have access to a portion of the system memory 2126. As with the CPU 2130, the GPU 2131 may include one or more processing units, and the processing units may include one or more cores. The system bus 2128 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 2126 may include a read-only memory (ROM) 2112 and a random access memory (RAM) 2146. A basic input/output system (BIOS) 2114, containing the basic routines that help transfer information between elements within the computing system 2100, such as during start-up, may be stored in the ROM 2112.

The computing system 2100 may further include a hard disk drive 2150 for reading from and writing to a hard disk, a magnetic disk drive 2152 for reading from and writing to a removable magnetic disk 2156, and an optical disk drive 2154 for reading from and writing to a removable optical disk 2158, such as a CD ROM or other optical media. The hard disk drive 2150, the magnetic disk drive 2152, and the optical disk drive 2154 may be connected to the system bus 2128 by a hard disk drive interface 2156, a magnetic disk drive interface 2158, and an optical drive interface 2150, respectively. The drives and their associated computer-readable media may provide nonvolatile storage of computer-readable instructions, data structures, program modules and other data for the computing system 2100.

Although the computing system 2100 is described herein as having a hard disk, a removable magnetic disk 2156 and a removable optical disk 2158, it should be appreciated by those skilled in the art that the computing system 2100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 2100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 2100 may also include a host adapter 2133 that connects to a storage device 2135 via a small computer system interface (SCSI) bus, a Fiber Channel bus, an eSATA bus, or using any other applicable computer bus interface. Combinations of any of the above may also be included within the scope of computer readable media.

A number of program modules may be stored on the hard disk 2150, magnetic disk 2156, optical disk 2158, ROM 2112 or RAM 2116, including an operating system 2118, one or more application programs 2120, program data 2124, and a database system 2148. The application programs 2120 may include various mobile applications (“apps”) and other applications configured to perform various methods and techniques described herein. The operating system 2118 may be any suitable operating system that may control the operation of a networked personal or server computer, such as Windows® XP, Mac OS® X, Unix-variants (e.g., Linux® and BSD®), and the like.

A user may enter commands and information into the computing system 2100 through input devices such as a keyboard 2162 and pointing device 2160. Other input devices may include a microphone, joystick, game pad, satellite dish, scanner, or the like. These and other input devices may be connected to the CPU 2130 through a serial port interface 2142 coupled to system bus 2128, but may be connected by other interfaces, such as a parallel port, game port or a universal serial bus (USB). A monitor 2134 or other type of display device may also be connected to system bus 2128 via an interface, such as a video adapter 2132. In addition to the monitor 2134, the computing system 2100 may further include other peripheral output devices such as speakers and printers.

Further, the computing system 2100 may operate in a networked environment using logical connections to one or more remote computers 2174. The logical connections may be any connection that is commonplace in offices, enterprise-wide computer networks, intranets, and the Internet, such as local area network (LAN) 2156 and a wide area network (WAN) 2166. The remote computers 2174 may be another a computer, a server computer, a router, a network PC, a peer device or other common network node, and may include many of the elements describes above relative to the computing system 2100. The remote computers 2174 may also each include application programs 2170 similar to that of the computer action function.

When using a LAN networking environment, the computing system 2100 may be connected to the local network 2176 through a network interface or adapter 2144. When used in a WAN networking environment, the computing system 2100 may include a router 2164, wireless router or other means for establishing communication over a wide area network 2166, such as the Internet. The router 2164, which may be internal or external, may be connected to the system bus 2128 via the serial port interface 2152. In a networked environment, program modules depicted relative to the computing system 2100, or portions thereof, may be stored in a remote memory storage device 2172. It will be appreciated that the network connections shown are merely examples and other means of establishing a communications link between the computers may be used.

The network interface 2144 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 2174.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations. Also, the program code may execute entirely on a user's computing device, on the user's computing device, as a stand-alone software package, on the user's computer and on a remote computer or entirely on the remote computer or a server computer.

The system computer 2100 may be located at a data center remote from the survey region. The system computer 2100 may be in communication with the receivers (either directly or via a recording unit, not shown), to receive signals indicative of the reflected seismic energy. These signals, after conventional formatting and other initial processing, may be stored by the system computer 2100 as digital data in the disk storage for subsequent retrieval and processing in the manner described above. In one implementation, these signals and data may be sent to the system computer 2100 directly from sensors, such as geophones, hydrophones and the like. When receiving data directly from the sensors, the system computer 2100 may be described as part of an in-field data processing system. In another implementation, the system computer 2100 may process seismic data already stored in the disk storage. When processing data stored in the disk storage, the system computer 2100 may be described as part of a remote data processing center, separate from data acquisition. The system computer 2100 may be configured to process data as part of the in-field data processing system, the remote data processing system or a combination thereof.

Those with skill in the art will appreciate that any of the listed architectures, features or standards discussed above with respect to the example computing system 1900 may be omitted for use with a computing system used in accordance with the various embodiments disclosed herein because technology and standards continue to evolve over time.

While the foregoing is directed to implementations of various technologies described herein, other and further implementations may be devised without departing from the basic scope thereof. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

What is claimed is:

1. A method, comprising:
receiving wellbore trajectory data for a reference wellbore section and for an offset wellbore section;
receiving uncertainty data for the reference wellbore section and for the offset wellbore section;
determining an analysis point in the reference wellbore section based on the received wellbore trajectory data;
determining a plurality of segments for the offset wellbore section based on the received wellbore trajectory data, wherein each segment is symmetrical about a center point of the segment;
determining a plurality of combined uncertainties corresponding to the analysis point and the plurality of segments based on the received uncertainty data;
determining a plurality of direct hit probabilities between the analysis point and the plurality of segments based on the plurality of combined uncertainties; and
drilling, or providing assistance for drilling, the reference wellbore section based on the plurality of direct hit probabilities.

2. The method of claim 1, wherein the received wellbore trajectory data for the reference wellbore section and for the offset wellbore section is generated based on one or more directional surveys of the reference wellbore section and the offset wellbore section using one or more sensors.

3. The method of claim 1, wherein a respective direct hit probability between the analysis point and a respective segment comprises a probability of a wellbore collision between the analysis point and a point within the respective segment.

4. The method of claim 1, wherein each of the plurality of segments has the same length.

5. The method of claim 1, wherein each of the plurality of segments has a length determined based on cross-sectional dimensions of the reference wellbore section and cross-sectional dimensions of the offset wellbore section.

6. The method of claim 1, wherein determining the plurality of combined uncertainties comprises:
determining uncertainty data corresponding to the analysis point based on the received uncertainty data;
determining uncertainty data corresponding to a respective segment based on the received uncertainty data, wherein the uncertainty data corresponding to the respective segment comprises uncertainty data corresponding to a center point of the respective segment; and
for the respective segment, combining the uncertainty data corresponding to the respective segment with the uncertainty data corresponding to the analysis point.

7. The method of claim 1, further comprising:
for a respective segment, assigning a respective combined uncertainty to the analysis point;
determining one or more combined cross-sectional dimensions by combining cross-sectional dimensions of the offset wellbore section with cross-sectional dimensions of the reference wellbore section; and
assigning the one or more combined cross-sectional dimensions to the offset wellbore section.

8. The method of claim 1, wherein determining the plurality of combined uncertainties comprises:
determining the eigenvectors corresponding to a respective combined uncertainty for a respective segment;
for the respective segment, determining a coordinate system based on the eigenvectors; and
determining a probability density distribution function corresponding to the respective segment based on the respective combined uncertainty and the coordinate system, wherein the probability density distribution function is a three-dimensional function.

9. The method of claim 8, wherein determining the plurality of direct hit probabilities between the analysis point and the plurality of segments comprises:
expanding the probability density distribution function corresponding to the respective segment into a Taylor expansion series for the respective segment; and
determining a respective direct hit probability between the analysis point and the respective segment based on an integration with respect to the respective segment of the expanded probability density distribution function, wherein the respective direct hit probability comprises an integration of at least a zero order and a second order term of the expanded probability density distribution function.

10. The method of claim 9, wherein the respective direct hit probability (P_{DH}) between the analysis point and the respective segment is determined by:
$${P}_{DH} = {f}_{X} {f}_{Y} {f}_{Z} π {R}_{1} {R}_{2} L + [ {f}_{X}^{″} {f}_{Y} {f}_{Z} + {f}_{X} {f}_{Y}^{″} {f}_{Z} + {f}_{X} {f}_{Y} {f}_{Z}^{″} ] \frac{π}{8} {R}_{1}^{4} L ,$$
wherein ƒ_{X}, ƒ_{Y}, and ƒ_{Z} are one-dimensional probability density distribution functions along principal axes of the coordinate system, R₁ and R₂ are combined cross-sectional radii assigned to the offset wellbore section, L is a length of each segment, and ƒ_{X}″, ƒ_{Y}″, and ƒ_{Z}″ are second derivatives of the probability density distribution function, and wherein ƒ_{X}″, ƒ_{Y}″, ƒ_{Z}″ and are evaluated at the center point of the respective segment.

11. The method of claim 10, wherein the cross-sectional radii are determined by:
R₁=R_{O}+R_{R} and R₂=R_{O}R_{R}|cos(β)|,
wherein R_{R} represents a radius of the reference wellbore section, R_{O} represents a radius of the offset wellbore section, and β represents an angle between a direction of the offset wellbore section and a direction of the reference wellbore section.

12. The method of claim 10, wherein the length of each segment is determined by:
L=\sqrt{3}(R_{R}+R_{O}),
wherein R_{R} represents a radius of the reference wellbore section and R_{O} represents a radius of the offset wellbore section.

13. The method of claim 1, further comprising:
determining a total direct hit probability between the analysis point and the plurality of segments based on a sum of the plurality of direct hit probabilities; and
drilling, or being used for drilling, the reference wellbore section based on the total direct hit probability.

14. The method of claim 13, wherein the total direct hit probability between the analysis point and the plurality of segments comprises a probability of a wellbore collision between the analysis point and the offset wellbore section.

15. A method, comprising:
receiving wellbore trajectory data for a reference wellbore section and for an offset wellbore section;
receiving uncertainty data for the reference wellbore section and for the offset wellbore section;
determining a plurality of segments for the offset wellbore section based on the received wellbore trajectory data, wherein each segment is symmetrical about a center point of the segment;
determining a plurality of analysis points in the reference wellbore section based on the received wellbore trajectory data;
determining a plurality of intervals for the reference wellbore section based on the plurality of analysis points, wherein a respective interval is formed by a pair of respective analysis points of the plurality of analysis points;
determining a plurality of combined uncertainties for the plurality of analysis points and the plurality of segments based on the received uncertainty data;
determining a plurality of direct hit probabilities between the plurality of intervals and the plurality of segments based on the plurality of combined uncertainties; and
drilling, or providing assistance for drilling, the reference wellbore section based on the plurality of direct hit probabilities.

16. The method of claim 15, wherein a respective direct hit probability between a respective interval and a respective segment comprises a probability of a wellbore collision between the respective interval and the respective segment.

17. The method of claim 15, wherein determining the plurality of combined uncertainties comprises:
determining uncertainty data corresponding to a respective analysis point based on the received uncertainty data;
determining uncertainty data corresponding to a respective segment based on the received uncertainty data, wherein the uncertainty data corresponding to the respective segment comprises uncertainty data corresponding to a center point of the respective segment; and
for the respective segment and the respective analysis point, combining the uncertainty data corresponding to the respective segment with the uncertainty data corresponding to the respective analysis point.

18. The method of claim 15, wherein each of the plurality of segments has a length determined based on a radius of the reference wellbore section and a radius of the offset wellbore section.

19. The method of claim 15, wherein determining the plurality of direct hit probabilities between the plurality of intervals and the plurality of segments comprises:
for a respective analysis point and a respective segment, determining a respective direct hit probability for the respective analysis point and the respective segment based on at least a zero order term and a second order term of a Taylor expansion series of a probability density distribution function corresponding to the respective analysis point and the respective segment;
for the respective analysis point and the respective segment, scaling the respective direct hit probability to relate the respective direct hit probability to an along-hole coordinate corresponding to the reference wellbore section; and
for a respective interval between a pair of respective analysis points, integrating the scaled respective direct hit probability over the respective interval.

20. The method of claim 15, further comprising:
determining a total direct hit probability between the plurality of intervals and the plurality of segments based on a sum of the plurality of direct hit probabilities; and
drilling, or being used for drilling, the reference wellbore section based on the total direct hit probability.

21. The method of claim 20, wherein the total direct hit probability between the plurality of intervals and the plurality of segments comprises a probability of a wellbore collision between the reference wellbore section and the offset wellbore section.

22. A method, comprising:
receiving wellbore trajectory data for a reference wellbore section and for an offset wellbore section;
receiving uncertainty data for the reference wellbore section and for the offset wellbore section;
determining an analysis point in the reference wellbore section based on the received wellbore trajectory data;
determining a cylindrical coordinate system based on the analysis point and the received wellbore trajectory data;
determining a plurality of wedges in the cylindrical coordinate system, wherein the plurality of wedges includes a region proximate to the offset wellbore section;
determining a plurality of combined uncertainties corresponding to the analysis point and the plurality of wedges based on the received uncertainty data;
determining a plurality of unintentional crossing probabilities between the analysis point and the offset wellbore section within the plurality of wedges based on the plurality of combined uncertainties; and
drilling, or providing assistance for drilling, the reference wellbore section based on the plurality of unintentional crossing probabilities.

23. The method of claim 22, wherein the region proximate to the offset wellbore section comprises a region that the reference wellbore section is to avoid.

24. The method of claim 22, wherein a respective unintentional crossing probability between the analysis point and the offset wellbore section within a respective wedge comprises a probability of the analysis point crossing a boundary of the region proximate to the offset wellbore section within the respective wedge.

25. The method of claim 22, wherein determining the plurality of wedges comprises:
determining a first coordinate system based on the wellbore trajectory data for the offset wellbore section and for the analysis point;
projecting the offset wellbore section onto a plane of the first coordinate system;
converting the plane and the offset wellbore section of the first coordinate system to a polar coordinate system;
determining a plurality of sectors in the polar coordinate system based on the received wellbore trajectory data and the analysis point, wherein the plurality of sectors is configured to include the offset wellbore section of the polar coordinate system; and
determining the plurality of wedges in the cylindrical coordinate system based on the plurality of sectors, wherein the plurality of wedges is formed by the plurality of sectors and a Z-axis that is perpendicular to the polar coordinate system.

26. The method of claim 25, wherein the first coordinate system comprises a XYZ coordinate system, wherein the XYZ coordinate system comprises an origin at the analysis point, a Y-axis parallel to a predominant direction of the offset wellbore section, a X-axis pointing from the origin perpendicularly onto the predominant direction of the offset wellbore section, and a Z-axis determined based on a vector product of the X-axis and Y-axis.

27. The method of claim 26, wherein the plane of the first coordinate system comprises a XY plane of the XYZ coordinate system, and wherein the plane of the polar coordinate system is determined based on a conversion of the XY plane to the polar coordinate system.

28. The method of claim 25, wherein:
the first coordinate system comprises a XYZ coordinate system, wherein the XYZ coordinate system comprises an origin at the analysis point and a Z-axis coincident with a predominant direction of the reference wellbore section; and
the plane of the first coordinate system comprises a XY plane of the XYZ coordinate system, wherein the XY plane is perpendicular to the predominant direction of the reference wellbore section.

29. The method of claim 22, wherein determining the plurality of combined uncertainties comprises:
determining uncertainty data for the analysis point based on the received uncertainty data;
determining uncertainty data for an intersection point for a respective wedge based on the uncertainty data, wherein the intersection point comprises a point at which a central plane of the respective wedge intersects the offset wellbore section; and
for the respective wedge, determining a respective combined uncertainty by combining the uncertainty data corresponding to the intersection point for the respective wedge with the uncertainty data corresponding to the analysis point.

30. The method of claim 22, wherein determining the plurality of unintentional crossing probabilities comprises determining a respective unintentional crossing probability between the analysis point and the offset wellbore section within a respective wedge based on an integral of a two-dimensional probability density distribution function corresponding to the respective wedge, wherein the integral comprises a product of one-dimensional probability density distribution functions in terms of radial distance and angular direction.

31. The method of claim 22, further comprising:
determining a respective unintentional crossing probability within a respective wedge for the analysis point crossing above the offset wellbore section within the respective wedge; and
determining a respective unintentional crossing probability within a respective wedge for the analysis point crossing below the offset wellbore section within the respective wedge.

32. The method of claim 22, further comprising:
determining a total unintentional crossing probability between the analysis point and the offset wellbore section within the plurality of wedges based on a sum of the plurality of unintentional crossing probabilities; and
drilling, or being used for drilling, the reference wellbore section based on the total unintentional crossing probability.

33. A method, comprising:
receiving wellbore trajectory data for a reference wellbore section and for an offset wellbore section;
receiving uncertainty data for the reference wellbore section and for the offset wellbore section;
determining one or more analysis points in the reference wellbore section based on the received wellbore trajectory data;
determining a plurality of segments for the offset wellbore section based on the received wellbore trajectory data, wherein each segment is symmetrical about a center point of the segment, and wherein the plurality of segments comprises a region proximate to the offset wellbore section;
determining a plurality of combined uncertainties corresponding to the one or more analysis points and the plurality of segments based on the received uncertainty data;
determining a plurality of unintentional crossing probabilities between the one or more analysis points and the offset wellbore section within the plurality of segments based on the plurality of combined uncertainties; and
drilling, or providing assistance for drilling, the reference wellbore section based on the plurality of unintentional crossing probabilities between the one or more analysis points and the offset wellbore section within the plurality of segments.

34. The method of claim 33, wherein the region proximate to the offset wellbore section comprises a region that the reference wellbore section is to avoid.

35. The method of claim 33, wherein a respective unintentional crossing probability between a respective analysis point and the offset wellbore section within a respective segment comprises a probability of the respective analysis point crossing into the respective segment.

36. The method of claim 33, wherein a respective segment has a length determined based on cross-sectional dimensions of the respective segment.

37. The method of claim 33, wherein determining the plurality of unintentional crossing probabilities comprises:
expanding a probability density distribution function corresponding to a respective segment into a Taylor expansion series for the respective segment; and
determining a respective unintentional crossing probability between a respective analysis point and the offset wellbore section within the respective segment based on an integration with respect to the respective segment of the expanded probability density distribution function, wherein the respective unintentional crossing probability comprises an integration of at least a zero order term and a second order term of the expanded probability density distribution function.

38. The method of claim 33, further comprising:
determining a total unintentional crossing probability between the one or more analysis points and the offset wellbore section within the plurality of segments based on a sum of the plurality of unintentional crossing probabilities; and
drilling, or being used for drilling, the reference wellbore section based on the total unintentional crossing probability between the one or more analysis points and the offset wellbore section within the plurality of segments.

39. The method of claim 33, further comprising:
determining a plurality of intervals for the reference wellbore section based on the one or more analysis points;
determining a plurality of unintentional crossing probabilities between the plurality of intervals and the offset wellbore section within the plurality of segments based on the plurality of combined uncertainties; and
drilling, or providing assistance for drilling, the reference wellbore section based on the plurality of unintentional crossing probabilities between the plurality of intervals and the offset wellbore section within the plurality of segments.

40. The method of claim 39, further comprising:
determining a total unintentional crossing probability between the plurality of intervals and the offset wellbore section within the plurality of segments based on a sum of the plurality of unintentional crossing probabilities; and
drilling, or being used for drilling, the reference wellbore section based on the total unintentional crossing probability between the plurality of intervals and the offset wellbore section within the plurality of segments.
